(19) United States
(12) Patent Application Publication
(10) Pub. No.: US 2019/0368978 A1
(43) Pub. Date: Dec. 5, 2019

(54) Underwater Sampling Method and Apparatus

(71) Applicant: Richard P. Sheryll, New York, NY (US)

(72) Inventor: Richard P. Sheryll, New York, NY (US)

(21) Appl. No.: 15/921,012

(22) Filed: Mar. 14, 2018

(51) Int. Cl. G01N 1/14; E21B 25/18; G01N 1/08; E21B 7/124

(52) U.S. Cl. CPC G01N 1/14; E21B 25/18; B63C 11/52; E21B 7/124; G01N 1/08

(57) ABSTRACT

Disclosed and claimed are methods and apparatuses for obtaining a sample with a sampler that includes a tip and tube that are positionable so as to be in or without fluid communication, and methods and apparatuses for obtaining a sub-sample therefrom while maintaining in situ pressure.

### REFERENCE TO EARLIER APPLICATION

This Application incorporates by reference and, under 35 U.S.C. § 119(e), claims priority to U.S. Provisional Patent Application Ser. No. 62/471,482 filed on Mar. 15, 2017. This Application incorporates by reference U.S. Pat. No. 5,559,295, issued Sep. 24, 1996.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

A significant fraction of the microbial biosphere exists at elevated hydrostatic pressure (up to 110 MPa; 1086 atm) and low temperatures, yet an understanding of microbial adaptation to these conditions, particularly pressure, is limited (e.g., Wang et al., 2008). Though recent advances in molecular biology is beginning to address the problem it remains unclear whether adaptation to the piezosphere results from changes in a few genes, broader modification of the genome or effected mainly via regulatory processes (e.g., Simonato et al., 2006). What is required to become a piezophile is an interesting unanswered question. Most pure culture piezophiles under study have been subjected to decompression at some time during their isolation, based on studies by Yayanos & Dietz (1983), suggesting that piezophiles still possessing some ability to grow at normal atmospheric pressure would survive decompression and with obligate piezophiles, the quasi-first order lethal effects due to decompression is slow enough that isolates can be obtained if decompression times are minimized (˜90% loss of viability of an obligate piezophile when decompressed for 5 hr). Jannasch & Wirsen (1984) obtained non-obligate piezophiles from the deep oceanic water column in the absence of decompression (Jannasch, et al., 1982). Later deep-sea microbial ecology studies began to show large discrepancies between deep sediments 16S rRNA clone libraries and isolates obtained in the laboratory from the same source (e.g., Parkes, et al., 2009; Frye et al., 2008). On the other hand, members of enrichment cultures obtained from undecompressed deep-sea surficial sediment inocula and cultured at high pressure for several enrichment cycles did correspond to the gene library generated from the source sediment; identical inocula cultivated at sea surface pressures did not (Yanagibayashi et al., 1999). From the perspective of obtaining bacterial clones that are at all representative of the organisms residing in deep sediments it is becoming clear that procurement and culture must be effected at the pressures of the environment from where they came.

From a biogeochemical standpoint, hydrostatic pressure can also dramatically influence chemical gradients within microbial ecosystems, particularly in environments where metabolic, geothermal or hydrocarbon seep mechanisms result in elevated gaseous inputs (e.g., carbon dioxide, methane, other hydrocarbon gases, hydrogen sulfide) are driven into solution by pressure. Preservation of sediment samples from the deep oceanic seep environments is a particular challenge in that the time between sampling and retrieval can be hours and changes in pressure, temperature can result in substantial out-gassing that destroys the structural integrity of the retrieved sediment sample as well as changes the composition and activity of the contained microbial communities.

Technology developed in the laboratory of R. Sheryll, the Deep Ocean Benthic Sampler (DOBS) possesses a capability that is unique to the fields of deep-sea microbial ecology, biogeochemistry, and natural products biotechnology, the ability to obtain a contamination-free sediment core and preserve in situ conditions of pressure and temperature upon retrieval to the ship. By application of proposed mechanisms for obtaining multiple sub-cores at various depth horizons within the retrieved core samples, in the absence of decompression, permits in concert a) accurate assessment of the gaseous (e.g., hydrocarbons) and chemical (e.g., bicarbonate, hydrogen sulfide, etc.) gradients within the core without being disturbed by the “homogenizing” out-gassing that typically occurs in such samples when collected by conventional coring operations, b) the phylogenetic (DNA, ribosomal RNA, [rRNA]), functional (messenger RNA, [mRNA]) molecular study and culture of the resident microbiota using high pressure hardware available within the Woods Hole Oceanographic Institution (WHOI) and c) procurement of sediment samples for subsequent isolation of pure clones in the absence of decompression.

Deep Ocean Sampling: A historical background of approaches, instrumentation and rationale for the development of DOBS. For sampling in deep waters where hydrostatic pressure is a parameter that can affect microbial viability and growth, pressure-retaining samplers have been implemented in a variety of designs for retrieval of samples in the absence of decompression. In 1968 the first prototype high pressure water sampler was tested (Gundersen & Mountain 1972), followed by pressure-retaining samplers “with” (Jannasch et al., 1973; Jannasch & Wirsen, 1977) and “without” (Tabor et al., 1981) sample inlet protection to reduce the potential for contamination. The Jannasch & Wirsen (1977) pressure-retaining samplers retrieve concentrated (3 liters of seawater filter concentrated to 13 ml) undecompressed microbial samples from depths down to 6000 m. Bianchi et al. (1999) expanded the concept of Jannasch and co-workers to a multi-chamber setup that allow up to 8 pressurized samples to be taken during a single deployment, though inlet protection is less rigorous (alcohol-sterilized parafilm).

In 1978, Art Yayanos used a pressure compensating sample chamber to capture for the first time live deep-sea macrofauna (Yayanos, 1978). These deep-sea macrofauna were adapted for high pressure and low temperature, where limited food is available. These conditions were considered by Wirsen & Jannasch (1975) while working with psychrophilic bacteria at elevated hydrostatic pressures. Taylor (1979) found that culturing marine organisms under a high pressure oxy-helium atmosphere (50.7 Mpa; 500 atm) did not alter microbe viability, which led to the first hyperbaric isolation chamber (Jannasch, et al., 1982; Taylor, 1987) that allows, in the total absence of decompression, water column microbes collected from the deep sea to be isolated into pure clones using standard streak plate technique at pressures up to 60.8 MPa; 600 atm. Isolates are obtained from filter-concentrated deep sea water samples (concentrated 230×) or settled sediment slurry samples are streaked onto the surfaces of various solid nutrient media contained in multiple culture dishes mounted on a conveyer belt within the pressure housing. Given the ubiquity of hydrothermal vent and cold water seep discoveries in recent years there has been renewed interest in fluid sampling systems for procuring vent and seep samples for chemical analysis, including gas-tight isobaric sampling of hydrothermal fluids (Seewald and Doherty, 2001). There continues to be interest in systems for the collection and cultivation of deep-sea microbes in absence of decompression (Malahoff et al., 2002; Kato, 2006).

The importance of uncontaminated microbial samples for genomic research has led to the development of the Autonomous Microbial Sampler (AMS). This sampling system will obtain uncontaminated and exogenous DNA-free microbial samples from marine, fresh water and hydrothermal ecosystems (Taylor et al., 2006). The device is capable of obtaining six uncontaminated and exogenous nucleic acid-free, potentially hot (up to 350° C.) aqueous samples from most freshwater, marine and hydrothermal ecosystems. Samples are obtained via a heat-exchanging titanium nozzle possessing six sterile, nucleic acid free inlets that are protected by removable caps. During sampling the protective cap of a given inlet tube is hydraulically expelled via a sterile, nucleic acid-free aqueous snubbing fluid and a filtered sample from the environment subsequently obtained on an in-line filter. Complete protection of samples from exogenous contamination was demonstrated by passage of the sampling nozzle through seawater containing 10⁶ cells ml⁻¹ of a pigmented tracer organism into tracer organism-free seawater. While the AMS is able to protect samples from damaging temperature change it does not attempt to maintain environmental pressures upon return of the samples. AMS uses the method described by the Sheryll patent to obtain uncontaminated water samples.

Another apparatus, the Deep Sea Environmental Sample Processor (ESP), has been developed by MBARI (Roman et al., 2007). This micro-laboratory utilizes robotic technology and “standard tests to detect gene products and answer specific questions: By detecting specific RNA sequences, the system can find out which organisms are present. Or, by testing for particular proteins, it can ask what those organisms are doing. (For example, an RNA test can look for a particular kind of harmful algae; a protein test can learn how much toxin it is producing)” (http://www.mbari.org/mars/general/deep_esp.html).

The first pressurized deep oceanic sediment cores were obtained at the Blake Ridge and Carolina Rise 1995 during an Ocean Drilling Program (ODP) cruise (Leg 164) by use of the Pressure Core Sampler (PCS), a device that is capable of maintaining in situ pressures up to 681atm (69.0 Mpa; depth ˜6810 m) (Francis, 2001). In 2003 the Multi-Autoclave-Corer (MAC) and the Dynamic Autoclave Piston Corer (DAPC) were deployed in shallow water gas hydrate bearing sediments in the northern Gulf of Mexico. The devices retrieved, for the first time, near surface sediment cores under ambient pressure. The systems were designed to recover sediment cores at in situ pressures of up to 14.2 Mpa; 140 atm (MAC) and 30.4 Mpa; 300 atm (DAPC) (Heeschen et al., 2007). Parkes et al. (2009) developed a deep-isoBUG system used for culturing deep sub-seafloor sediments in absence of decompression (up to 25 MPa, 247 atm). Subsamples can subsequently be repressurized isolated and cultured at pressures up to 100 MPa (987 atm). Deep-isoBUG cooperatively works with the pressure retaining drill coring system called HYACINTH or PCS. The two systems are coupled together and a sub-core can be cut from the drill core while maintained inside the pressure retaining portion of the drill called the PRESS. The systems collectively allow sub-seafloor sediment samples to be sub-sampled and transferred into an isolation culture chamber of a design similar to the device described by Jannasch et al., (1982) or a chemostat for further processing and culture. Deep-isoBUG is essentially a subsampling transfer system. This system differs from DOBS in several ways; DOBS collects uncontaminated layer sediment core samples in absence of decompression for depths as great as 6,800 m, corresponding to a pressure 68.5MPa (>676 atm). Our Core Subsampling Unit (CSU, described later) works in a similar manner, where the subsample is transferred using a pushrod to move a subsample from one unit to the other. Surficial deep sea scoop sediment samples (˜5 ml) obtained by the manned submersible Shinkai 6500 have been successfully brought to the sea surface in a pressure and temperature retaining device (Kato, 2006) and enrichment cultures obtained in the absence of decompression (Yanagibayashi et al., 1999) in a large laboratory high pressure culture system called DeepBath (Kato, 2006). As indicated in the Introduction, several of the organisms found in the high pressure enrichments corresponded to the 16S rRNA clone library sequences found in the source sediments (not the case when the same sediments were enriched at 0.1 MPa, 1 atm); again relaying the importance of retaining in situ pressures in studies of the microbial ecology of the deep sea.

Generally lacking in deep-sea microbial ecology is a sampling approach that a) unequivocally guarantees procurement of uncontaminated sediment core samples from the deep sea, b) is able to maintain deep-sea conditions of low temperatures and high pressures upon return of the sample to the laboratory and c) possesses a mechanism for obtaining core sections under pressure to allow assessment of microbial diversity with depth in the sediment. To our knowledge, the only sampling technology in existence that possesses this unique combination of capabilities to the full depth of the ocean is the DOBS. Additionally, DOBS has been designed for flexible application; with some modification, the device can collect any type of sample found in the oceans whether it be live animals, minerals, water samples or sediment core samples, including the benthic boundary layer.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is an image of a sediment core sampling device configured according to principles of the invention;

FIG. 2A is a vertical cross-sectional detail view of the embodiment of FIG. 1 in operation;

FIG. 2B is a vertical cross-sectional detail view of the embodiment of FIG. 1 in operation;

FIG. 2C is a vertical cross-sectional detail view of the embodiment of FIG. 1 in operation;

FIG. 2D is a vertical cross-sectional detail view of the embodiment of FIG. 1 in operation;

FIG. 2E is a vertical cross-sectional detail view of the embodiment of FIG. 1 in operation;

FIG. 2F is a vertical cross-sectional detail view of the embodiment of FIG. 1 in operation;

FIG. 3A is a vertical cross-sectional detail view of a core sub-sampling unit configured according to principles of the invention;

FIG. 3B is a vertical cross-sectional detail view of a core sub-sampling unit configured according to principles of the invention;

FIG. 4A is a schematic of the embodiment of FIG. 3 in operation;

FIG. 4B is a schematic of the embodiment of FIG. 3 in operation;

FIG. 4C is a schematic of the embodiment of FIG. 3 in operation;

FIG. 4D is a schematic of the embodiment of FIG. 3 in operation;

FIG. 4E is a schematic of the embodiment of FIG. 3 in operation;

FIG. 4F is a schematic of the embodiment of FIG. 3 in operation;

FIG. 4G is a schematic of the embodiment of FIG. 3 in operation;

FIG. 5A is an environmental perspective view of the embodiment of FIG. 3 in operation;

FIG. 5B is an environmental perspective view of the embodiment of FIG. 3 in operation;

FIG. 5C is an environmental perspective view of the embodiment of FIG. 3 in operation;

FIG. 5D is an environmental perspective view of the embodiment of FIG. 3 in operation;

FIG. 5E is an environmental perspective view of the embodiment of FIG. 3 in operation;

FIG. 5F is an environmental perspective view of the embodiment of FIG. 3 in operation;

FIG. 5G is an image of the embodiment of FIG. 3;

FIG. 5H is an image of the embodiment of FIG. 3;

FIG. 5I is an environmental perspective view of the embodiment of FIG. 3 in operation;

FIG. 5J is an environmental perspective view of the embodiment of FIG. 3 in operation;

FIG. 5K is an environmental perspective view of the embodiment of FIG. 3 in operation;

FIG. 5L is an environmental perspective view of the embodiment of FIG. 3 in operation;

FIG. 5M is an environmental perspective view of the embodiment of FIG. 3 in operation;

FIG. 5N is an environmental perspective view of the embodiment of FIG. 3 in operation;

FIG. 5O is an environmental perspective view of the embodiment of FIG. 3 in operation;

FIG. 6 is a side elevational view of a deep ocean benthic sampling apparatus configured according to principles of the invention;

FIG. 6A is an environmental perspective view of the embodiment of FIG. 6 being deployed;

FIG. 6B is an image of the embodiment of FIG. 6A;

FIG. 7A is a side elevational view of an apparatus for transferring sub-core contents transformed into a slurry configured according to principles of the invention;

FIG. 7B is a vertical cross-sectional detail view of an apparatus for transferring sub-core contents transformed into a slurry configured according to principles of the invention;

FIG. 7C is a vertical cross-sectional detail view of an apparatus for transferring sub-core contents transformed into a slurry configured according to principles of the invention;

FIG. 7D is a vertical cross-sectional detail view of an apparatus for transferring sub-core contents transformed into a slurry configured according to principles of the invention;

FIG. 7E is a vertical cross-sectional detail view of an apparatus for transferring sub-core contents transformed into a slurry configured according to principles of the invention;

FIG. 7F is a vertical cross-sectional detail view of an apparatus for transferring sub-core contents transformed into a slurry configured according to principles of the invention;

FIG. 8 is a rear, side elevational view of a sub-core extractor configured according to principles of the invention;

FIG. 8A is a vertical cross-sectional detail view of a sub-core extractor configured according to principles of the invention;

FIG. is a side elevational view of the embodiment of FIG. 8 in operation;

FIG. 9A is a side elevational view of the embodiment of FIG. 8 in operation;

FIG. 9B is a side elevational view of the embodiment of FIG. 8 in operation;

FIG. 9C is a side elevational view of the embodiment of FIG. 8 in operation;

FIG. 9D is a side elevational view of the embodiment of FIG. 8 in operation;

FIG. 9E is a side elevational view of the embodiment of FIG. 8 in operation;

FIG. 9F is a side elevational view of the embodiment of FIG. 8 in operation;

FIG. 9G is a side elevational view of the embodiment of FIG. 8 in operation;

FIG. 9H is a side elevational view of the embodiment of FIG. 8 in operation;

FIG. 9I is a side elevational view of the embodiment of FIG. 8 in operation;

FIG. 9J is a side elevational view of the embodiment of FIG. 8 in operation;

FIG. 10A is a side elevational view of a sub-core piston assembly configured according to principles of the invention;

FIG. 10B is an end view of the embodiment of FIG. 10;

FIG. 10C is an end view of the embodiment of FIG. 10;

FIG. 10D is a side elevational view of a sub-core piston assembly configured according to principles of the invention;

FIG. 10E is a vertical cross-sectional detail view of the embodiment of FIG. 10;

FIG. 10F is a vertical cross-sectional detail view of the embodiment of FIG. 10;

FIG. 11 is a vertical cross-sectional detail view of a sub-core piston assembly in operation;

FIG. 11A is an enlarged view of the embodiment of FIG. 11;

FIG. 11B is an enlarged view of the embodiment of FIG. 11;

FIG. 11C is a front, side elevational view of the embodiment of FIG. 10;

FIG. 12A is vertical cross-sectional detail view of a sub-core piston assembly in operation;

FIG. 12B is an enlarged view of the embodiment of FIG. 12A;

FIG. 12C is an enlarged view of the embodiment of FIG. 12A;

FIG. 12D is an enlarged view of the embodiment of FIG. 12A;

FIG. 12E is an enlarged view of the embodiment of FIG. 12A;

FIG. 12F is an enlarged view of the embodiment of FIG. 12A;

FIG. 12G is an enlarged view of the embodiment of FIG. 12A;

FIG. 13 is a vertical cross-sectional detail view of a ball valve freeze assembly in operation;

FIG. 13A is a front, side elevational view of a freeze assembly hard stop configured according to principles of the invention;

FIG. 13B is an enlarged view of the embodiment of FIG. 13;

FIG. 13C is an enlarged view of the embodiment of FIG. 13;

FIG. 13D is an enlarged view of the embodiment of FIG. 13;

FIG. 13E is an enlarged view of the embodiment of FIG. 13;

FIG. 13F is an enlarged view of the embodiment of FIG. 13;

FIG. 14 is a vertical cross-sectional detail view of a ball valve freeze assembly configured according to principles of the invention;

FIG. 14A is a side elevational view of a ball valve freeze assembly configured according to principles of the invention;

FIG. 15 is a side elevational view of ball freeze assembly configured according to principles of the invention;

FIG. 16A is a vertical cross-sectional detail view of a ball freeze assembly configured according to principles of the invention;

FIG. 16B is an enlarged view of the embodiment of FIG. 16A;

FIG. 16C is a side elevational view of the embodiment of FIG. 16A;

FIG. 16D is a front elevational view of the embodiment of FIG. 16A;

FIG. 16E is a rear elevational view of the embodiment of FIG. 16A;

FIG. 16F is a side elevational view of the embodiment of FIG. 16A;

FIG. 16G is a side elevational view of the embodiment of FIG. 16A;

FIG. 16H is a side elevational view of a core subsampling unit, without outer case, configured according to principles of the invention;

FIG. 16I is a side elevational view of a core subsampling unit, with outer case, configured according to principles of the invention;

FIG. 16J is a vertical cross sectional detail view of the embodiment of FIG. 16A;

FIG. 16K is a rear elevational view of the embodiment of FIG. 16A;

FIG. 16L is a front elevational view of the embodiment of FIG. 16A;

FIG. 16M is a side elevational view of the embodiment of FIG. 16A;

FIG. 16N is a vertical cross sectional detail view of the embodiment of FIG. 16A;

FIG. 16O is a side elevational view of a core subsampling unit, without outer case, configured according to principles of the invention;

FIG. 16P is a side elevational view of a core subsampling unit, with outer case, configured according to principles of the invention;

FIG. 16Q is a side elevational view of a core subsampling unit configured according to principles of the invention;

FIG. 16R is an exploded view of the embodiment of FIG. 16F;

FIG. 16S is a vertical cross sectional detail view of a core subsampling unit configured according to principles of the invention;

FIG. 17 is a vertical cross-sectional detail view of obtaining a sub core from a core;

FIG. 17A is a vertical cross-sectional detail view of obtaining a sub core from a core;

FIG. 17B is a vertical cross-sectional detail view of obtaining a sub core from a core;

FIG. 17C is a vertical cross-sectional detail view of obtaining a sub core from a core;

FIG. 17D is a vertical cross-sectional detail view of obtaining a sub core from a core;

FIG. 18 is a vertical cross-sectional detail view of obtaining a sub core from a core;

FIGS. 18A is an enlarged view of the embodiment of FIG. 18;

FIG. 18B is a front, side elevational view of a freeze assembly hard stop configured according to principles of the invention;

FIGS. 18C is an enlarged view of the embodiment of FIG. 18;

FIG. 18D is a side elevational view of the embodiment of FIG. 18A;

FIGS. 18E is an enlarged view of the embodiment of FIG. 18;

FIG. 19 is an image of the embodiment of FIG. 18A;

FIG. 20 is an image of a goniometer cart configured according to principles of the invention;

FIG. 21A is an image of a core subsampling unit configured according to principles of the invention;

FIG. 21B is an image of a core subsampling unit configured according to principles of the invention;

FIG. 21C is a side elevational view, partially in cross section, of obtaining a sub core from a core;

FIG. 22 is an image of a goniometer cart configured according to principles of the invention;

FIG. 23A is a plan view of a goniometer alignment cart configured according to principles of the invention;

FIG. 23B is a top, front, left side elevational view of a goniometer alignment cart configured according to principles of the invention;

FIG. 23C is a right side elevational view of a goniometer alignment cart configured according to principles of the invention;

FIG. 23D is a left side elevational view of a goniometer alignment cart configured according to principles of the invention;

FIG. 23E is a front elevational view of a goniometer alignment cart configured according to principles of the invention;

FIG. 23F is a bottom view of a goniometer alignment cart configured according to principles of the invention;

FIG. 24 is a top, front elevational view of a deep ocean benthic sampling apparatus configured according to principles of the invention;

FIG. 25 is a front elevational view of the embodiments of FIGS. 6 and 23 operatively connected;

FIG. 26 is a top elevational view of the embodiments of FIGS. 6 and 23 operatively connected;

FIG. 27A is an image of the embodiment of FIG. 6 being deployed;

FIG. 27B is an image of the embodiment of FIG. 6 being deployed;

FIG. 27C is an image of the embodiment of FIG. 6 being deployed;

FIG. 28A is an assembled view of a sample cavity configured according to principles of the invention;

FIG. 28B is an exploded view of a sample cavity configured according to principles of the invention;

FIG. 29 is an image of the embodiment of FIG. 28;

FIG. 30A is a top, side elevational view of a sample acquisition device configured according to principles of the invention;

FIG. 30B is a top, side elevational view of a sample acquisition device configured according to principles of the invention;

FIG. 31A is a bottom, side elevational view of a portion of the embodiment of FIG. 30;

FIG. 31B is a bottom, side elevational view of a portion of the embodiment of FIG. 30;

FIG. 32A is a vertical, cross sectional detail view of the embodiment of FIG. 30 obtaining a sample;

FIG. 32B is a vertical, cross sectional detail view of the embodiment of FIG. 30 obtaining a sample;

FIG. 32C is a vertical, cross sectional detail view of the embodiment of FIG. 30 obtaining a sample;

FIG. 32D is a vertical, cross sectional detail view of the embodiment of FIG. 30 obtaining a sample;

FIG. 32E is a vertical, cross sectional detail view of the embodiment of FIG. 30 obtaining a sample;

FIG. 32F is a vertical, cross sectional detail view of the embodiment of FIG. 30 obtaining a sample;

FIG. 33A is a vertical, cross sectional detail view of a portion of the sample tube of the embodiment of FIG. 30;

FIGS. 33B is a vertical, cross sectional detail view of a portion of the sample tube of the embodiment of FIG. 30;

FIGS. 33C is a vertical, cross sectional detail view of a portion of the sample tube of the embodiment of FIG. 30;

FIGS. 33D is a vertical, cross sectional detail view of a portion of the sample tube of the embodiment of FIG. 30;

FIG. 34 is a side elevational view of a sample acquisition device configured according to principles of the invention;

FIG. 35A is a side elevational view of a housing of the embodiment of FIG. 34;

FIG. 35B is an exploded view of the embodiment of FIG. 34;

FIG. 36A is a side and exploded view of a piston puller configured according to principles of the invention;

FIG. 36B is a side view of a piston puller configured according to principles of the invention;

FIG. 36C is an exploded view of a piston puller configured according to principles of the invention;

FIG. 37 is an environmental perspective view of sample acquisition device configured according to principles of the invention;

FIG. 38 is an environmental perspective view of the embodiment of FIG. 37, shown partially transparent;

FIG. 39 is an environmental perspective view of the embodiment of FIG. 37 without a sample tube;

FIG. 40 is an environmental perspective view of the embodiment of FIG. 39;

FIG. 41 is an environmental perspective view of the embodiment of FIG. 39, shown partially transparent;

FIG. 42 is an enlarged view of a portion of the embodiment of FIG. 39;

FIG. 43 is an enlarged view of a portion of the embodiment of FIG. 39, shown partially transparent;

FIG. 44 is a schematic view of a gas filling system configured according to principles of the invention; and

FIG. 45 is an image of the embodiment of FIG. 44.

### DETAILED DESCRIPTION OF THE PREFERRED EMBODIMENTS

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

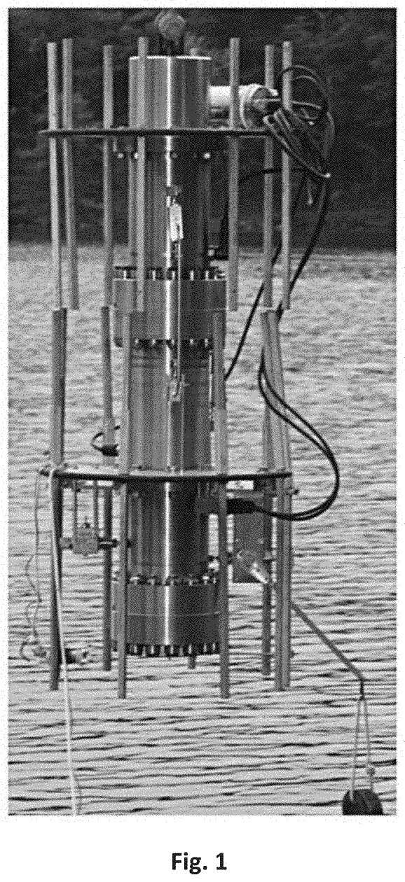

General Description of DOBS: The Deep Ocean Benthic Sampler (DOBS; FIG. 1) in its present operational embodiment has been designed and built by Richard Sheryll. The device is a sediment core sampling device, but also can be part of an integrated high-pressure research system that can be interfaced with high pressure technology that exists within the Woods Hole Oceanographic Institution (WHOI) for the obtaining pure bacterial clones (Isolation Chamber, Jannasch et al., 1982; Taylor, 1987), batch culture (Taylor & Jannasch, 1976; Taylor, 1978; Jannasch & Wirsen, 1977) and continuous culture (Jannasch et al., 1982; Wirsen & Molyneaux, 1999) of bacteria under deep-sea conditions, in the absence of decompression. Additionally DOBS can be a molecular tool, permitting collection of sediment samples in a manner compatible with the latest techniques in molecular microbial ecology involving DNA, rRNA and the short half-lived mRNA. DOBS is the first available technology that will permit the unbiased functional molecular analyses (rRNA, mRNA based) of deep-sea sediments.

The main mechanism by which DOBS can deliver sediment samples with their rRNA and short-lived mRNA signatures intact is by its ability to maintain the samples at in situ conditions during recovery to the sea surface and ship's laboratory. All of the physico-chemical conditions (e.g., temperature, pressure, chemical and redox gradients, etc.) that would alter microbe viability and the nucleic acid signatures, particularly that of mRNA, are maintained as though the sediment sample were still in situ. Physiologically and biochemically, the organisms are ‘unaware’ that they have been removed from the sea floor, at least for the trip to the ships laboratory. The DOBS achieves this primarily by maintenance of in situ pressure and temperature; the slowness of diffusion processes maintains the chemical properties of the sample. In situ pressure is maintained within DOBS by use of a helium gas (or other gas) cushion in a manner similar to how the Jannasch & Wirsen water samplers (Jannasch et al., 1973, Jannasch et al., 1976, Jannasch & Wirsen 1977, 1982) maintained deep-sea water samples at in situ pressures. Because gas is a compressible medium very little pressure change occurs within the sample during the inevitable dimensional changes in the vessel that occurs on its way to the sea surface.

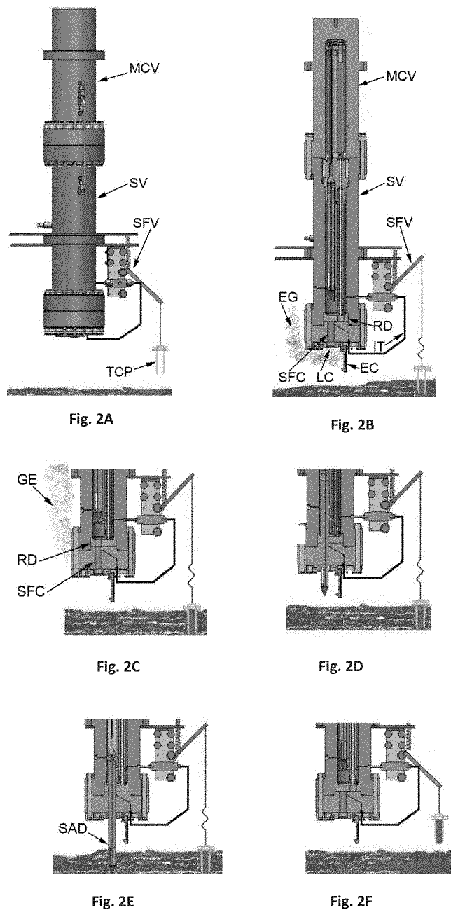

DOBS consists of two separable pressure chambers (FIGS. 2A, Upper Chamber [(green] (MCV), Lower Chamber [gray] (SV)), that are pressure sealed end-to-end and each pre-charged with pressurized gas (helium or others). The lower chamber is sealed by a Rotating Door (RD) that interfaces with a small Snubbing Fluid Chamber (SFC) that is pre-filled with an essentially non-compressible snubbing fluid (sterile deionized water) that is separated from the external environment by an internally sterile Trap Door (LC) (FIG. 2B). Collectively, these chambers operate to create a sterile and controllable gas/fluid interface allowing for consistent, reliable and non-contaminating sample acquisition. The upper Motion Control Vessel (MCV) contains motion control components for actuating the sediment coring operations and the lower Sample Vessel (SV) houses the actual coring apparatus. Both chambers are pre-pressurized with helium (or other gas) to pressures slightly greater than that of the deep-sea environment the sample is to be obtained and can be separated without losing pressure in either chamber. This feature allows maintenance of motion control components, and the ability to exchange out the SV's with additional units for continued sediment sampling during a cruise. The MCV contains two motors, one of which controls the opening and closing of the RD. The other motor controls the vertical movement of the Sample Acquisition Device (SAD) probe, which obtains the sediment core. The motor is attached through gearing to an acme screw (or other linear motion device), which drives the SAD probe in and out of the sample chamber to acquire the sediment cores.

Functioning of DOBS on the seafloor: A diagrammatic representation of DOBS functions are shown in FIGS. 2A-f. When the DOBS reaches the seafloor the SFC Trap Door is mechanically opened as well as the Snubbing Fluid Valve (SFV) by a mechanical Trigger Pad Corer (TCP), which in addition to triggering DOBS sampling, also is a piston core sampler for obtaining core samples in the classic manner (i.e., no control of temperature and sample decompressed). (The trigger to can by controlled by other methods such as solenoid or corrosive link for example). The internal gas pressure in the SV and MCV (which is a calculated amount greater than ambient) is released via the SFV through the SFC, forcing out the snubbing fluid and equilibrating the pressure within the SV and MCV with the environment (FIG. 2B, blue gas bubbles EG). When the internal and external pressures have been equalized (sensed by internal and external pressure sensors), an electrical motor is turned on, to open the RD in the SV (FIG. 2C). The passageway in the SFC now contains sterile gas that communicates with environment via a gas/seawater interface. When the RD is fully open the SAD probe motor is turned on and deploys the SAD piston corer probe into the sediment (FIGS. 2D), the core piston is tethered via a synthetic cable (or telescopic rod, solid rod or rod-cable combination) so that it is maintained in position during acquisition of the core). When the SAD reaches the bottom of its stroke, procuring a core, and the tip of the SAD probe is rotated 90° by a mechanical linkage inside the SAD probe, which seals in the sample core (FIG. 2E; a current sensor in the SAD motor terminates the coring operation should the SAD strike a hard object, preventing damage to DOBS components). A micro-switch is triggered and the SAD motor reverses and withdraws the now sealed SAD probe from the sediment, back into SV. When the SAD probe is fully returned into the SV the SAD motor is turned off and the RD is activated in reverse to close the entrance to the sample chamber (FIG. 2F). The SV is now sealed and retains in situ pressure when the DOBS is returned to the sea surface and ship. The time required for the DOBS coring operation on the bottom is only ˜6.5 minutes. Sample temperature is maintained by the mass of the high pressure chambers, a layer of open cell foam wrapped around DOBS to prevent convective heat gain and the fact that only the upper ˜200 m of ocean is significantly above 3-5° C. Other methods can be used to maintain temperature of the DOBS if required, such as other types of insolating raps or a small pressure enclosed cooling compressor with coils rapped around the outer portion of the sample chamber to keep it from changing temperature.

DOBS was built to maintain samples from depths of A800 m depth at in situ pressures, 66.4 Mpa (655 ATM) with a ≥4× safety factor. DOBS can safely hold gas pressures up to 2,620 ATM (266 Mpa) before elastic deformation occurs in the vessel. Additionally, DOBS is outfitted with a safety relief valve which will vent the contained gas long before these pressures would be reached (venting begins at user-determined pressures).

DOBS has been designed to accept additional SV's, allowing rapid recycling of the instrument and acquisition of additional cores while the core just retrieved is being processed. The SV can also be modified from its present design to contain multiple SAD probes for acquiring multiple core samples.

Technical Objectives DOBS System:

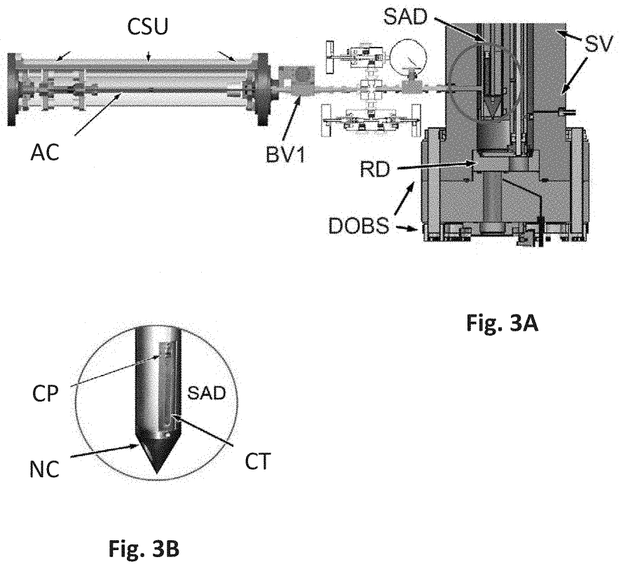

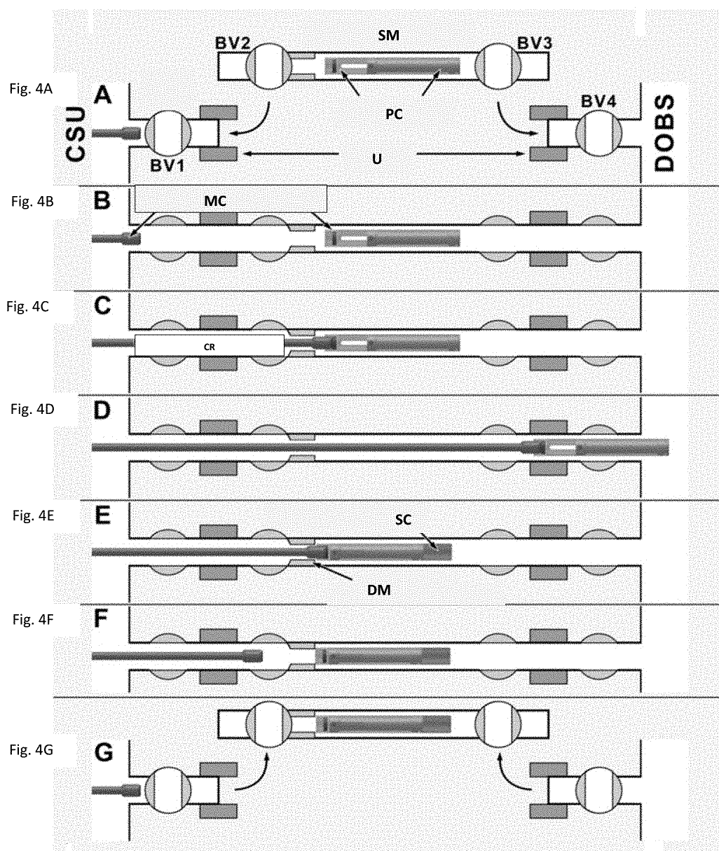

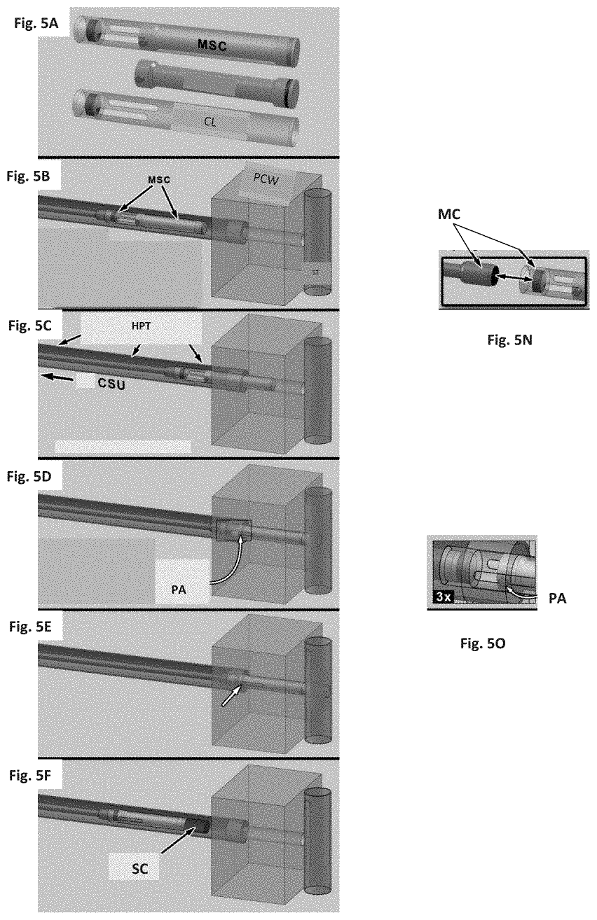

Construction of Core Subsampling Unit: Ultimately, a core subsample must be taken from the undecompressed core housed within the SAD probe at a given depth horizon for subsequent molecular or microbial analysis. Hardware for executing this operation is done by the Core Subsampling Unit (CSU) (or called the Sub Core Extractor (SCE)). The device, shown in FIG. 3, consists of a pressure housing containing high pressure gas or gas mixture, within which is housed the hardware for movement of a magnetically detachable ¼″ OD Miniature Sub-Corer (MSC) (or called Sub Core Probe Assembly). The MSC is in effect a miniature piston corer, the function of which will be discussed momentarily. The CSU is mechanically connected to a subsampling port within the DOBS pressure housing via high pressure tubing and three or four associated ball valves as diagrammatically illustrated in FIG. 4, (the 3 ball valve method will be described later).

The following components of the invention shall be referred to by the immediately-following parenthetical abbreviation: Miniature Sub-Corer (MSC), Sample Vessel (SV), Acme Screw (AC), Sample Acquisition Device (SAD), Piston Core (PC), Nose Cone (NC), Core Tube (CT), Ball Valves (BV1), Deep Ocean Benthic Sampler (DOBS), Rotating Door (RD), Sample Module (SM), Ball Valves (BV), Unions (U), coupling magnets (DM), Core Liner (CL), Pressure Casing Wall (PCW), Magnetic Coupling (MC), Sample Tube (ST), High Pressure Tubing (HPT), Ledge to Anchor Piston (PA), Subsample Core (SC).

FIG. 4 is a diagrammatic illustration of sub-coring operations via the Core Sub-sampling Unit (CSU).

Prior to the sub-coring operation, the CSU and the SV of DOBS are disconnected as shown in FIG. 4A, each sealed from the environment via Ball Valves (BV) 1 and 4. The MSC is housed within a Sample Module (SM) [later called the Ball Valve Freeze Assembly (BVFA)]; a length of non-magnetic stainless steel or titanium tubing sealed by BVs 2 and 3. The SM and MSC contained within are previously treated with DNA away, flushed with low pressure helium (or other gas or gas mixture) and autoclave sterilized. To streamline the subsampling operation multiple SM's are prepared ahead. A given SM is connected to the CSU via a Union and to the SV by a second Union (collectively U) as shown in FIG. 4A. The SM is pressurized from the CSU and SV by sequential opening of BVs 1-4, allowing high pressure gas communication between the MSC and SV (FIG. 4B). The SAD within the SV is aligned with the sub-coring port in the SV via its acme screw and the acme screw within the CSU advances a connecting rod equipped with a rare earth Magnetic Coupling (MC) to strongly unite with the opposite pole of the MC on the MSC as shown in FIG. 4C. The MSC continues its advance into the sub-coring port of the SV (FIG. 4D) and ultimately into the SAD core. The SAD core possesses a slot along its length and is sealed by a length of sterilizable heat shrink tubing shrunk into place (or other method such as a series of ports located so samples can be extracted from the ports). This permits the SAD to be “cored” by the MSC at any position along its length (or at discrete port locations). Once the sub-core (SC) is taken the acme screw is reversed, drawing the MSC sub-core from the SAD, the SV and back into the SM (FIG. 4E). The coupling magnet connected to the MSC is of large enough diameter to be captivated by an annular ledge within the SM that disengages the coupling magnets, leaving the MSC with its sub-core within the SM (FIG. 4F). The MSC coupling magnet is drawn back into the CSU, BVs 1-4 closed, and the pressurized SM containing the sub-core removed from the system (FIG. 4G).

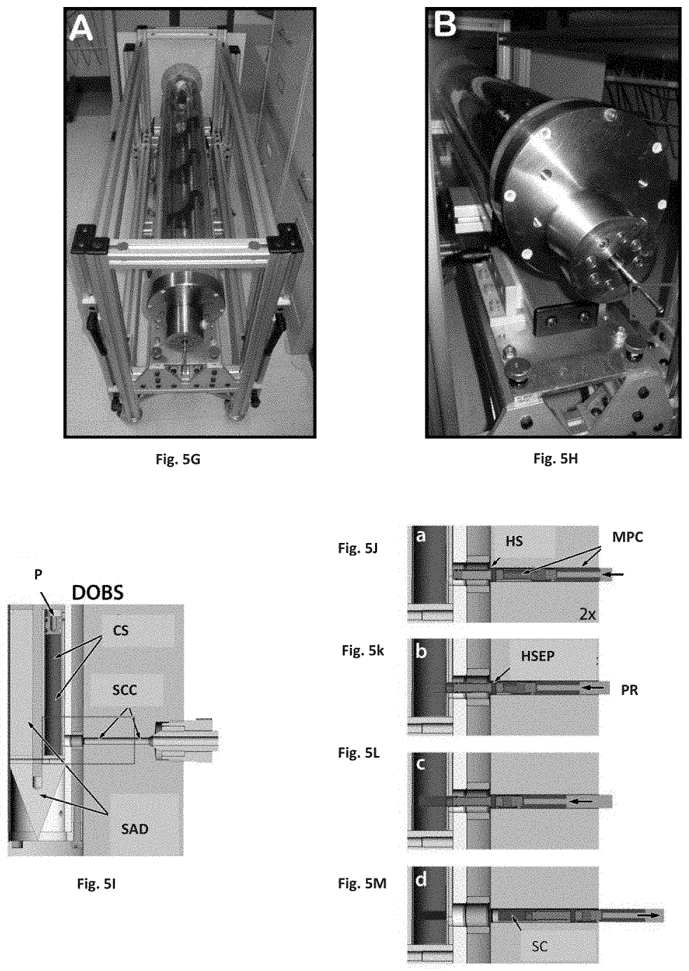

FIG. 5 is a diagrammatic sequence of sub-coring operations. The approach implements the proposed Miniature Sub-corer (MSC) that obtains a sediment sub-sample from the DOBS Sample Acquisition Device (SAD).

An advantage of the SM concept is that multiple units can be sterilized ahead of time and the entire core within the SAD sub-cored within a reasonable time without need for decompressing the CSU between sub-cores (there are two versions of the CSU or SCE one with pressure housing and one which does not require a pressure housing). The SM units can be quickly decompressed and sample core removed for subsequent molecular analysis. Two options are possible with this subsampling system: A), the sediment subsample contained within the SM is frozen while still pressurized by pouring liquid nitrogen over the tubing section. The sample can be stored in a pressurized, frozen state until processing. During sample processing the SM is quickly decompressed, the MSC removed and the frozen core ejected for further molecular processing. As an alternative, B), the MSC within the SM is not frozen, the unit decompressed, the MSC removed and the unfrozen core expelled and mixed with a chemical preservative (e.g., RNAlater; time required from decompression to preservation <15 sec).

A 3D representation of the sub-coring operation is diagrammatically illustrated in FIG. 5. An exploded and assembled view of the MSC is shown in FIG. 5A, showing a floating O-ring sealed piston that telescopes within the small, sharp-edged titanium core tube and captivated within a slot by a small pin (core tube made transparent for visualization). The slot controls the extent of movement of the floating piston. FIG. 5B corresponds to the sampling stage illustrated in FIG. 4D as the MSC is pushed through the DOBS pressure case wall into the SV (FIGS. 5B, C). When the edge of the core tube reaches the SAD core, the pin shown in FIG. 5A simultaneously arrives at a ledge within the SV conduiting, anchoring the floating piston at that position (FIG. 5D, 3× inset). As the core tube continues to advance into the SAD core (FIG. 5C, D) a piston core sample is taken (˜0.4 ml sample). When the MSC is withdrawn, the O-ring friction between the core tube and piston and the magnetic coupling strong enough to withdraw a complete sub-core (FIG. 5E, corresponding to FIG. 4E) from the SAD core. Not shown in this drawing, all orifice entries will be appropriately chamfered to allow entry of the MSC, pushrod magnet assemblies, etc. given the slight misalignments that will inevitably occur. The acme screw concept is similar to that used in the DOBS and has been fully tested. The engineering details of the MSC, SM, etc. are conceptually illustrated in FIGS. 4 and 5.

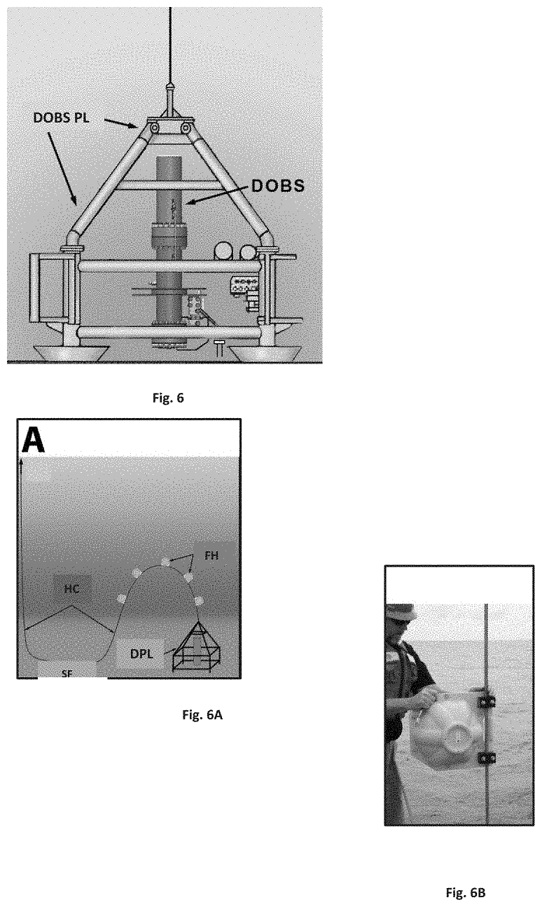

Construction of the DOBS deployment platform: For acquisition of the sediment samples outlined above DOBS will need to be outfitted with a quadrilateral pyramid bottom lander similar to that illustrated in FIG. 6 that can be deployed by the ship's hydro-winch and distributes the weight evenly across 4 fairly large landing pads. Because the DOBS uses a linearly deployed sample acquisition probe with a stroke of approximately 48 cm having the DOBS level and at a constant height above the sediment surface will be important to guarantee that full length core samples are taken. This will be executed by mounting the DOBS on a gimbaled mount within the lander that will keep the sampler vertically oriented. The vertical positioning of DOBS can be controlled by an aqueous hydraulic ram that is in hydraulic lock by a metering valve that is in the closed position. When the bottom lander is a few feet off the bottom the same TCP that triggers the DOBS sequence also opens the metering valve. The weight of the DOBS is the driving force slowly expelling water out of the ram and allowing DOBS to slowly settle in vertical position. A second mechanical trigger pad switches off the metering valve when DOBS has reached the proper distance off the sea floor, again in hydraulic lock. The DOBS controlling electronics package has built in delays to accommodate the time required for DOBS to settle into vertical position. The bottom lender is made from marine grade aluminum tubing.

To prevent cable entanglement with the DOBS during deployment syntactic foam cable floats (not shown in figure). These are attached to the ships hydro wire starting just above the attachment point of the sampler to prevent the cable falling onto the sampler when the hydro cable goes slack (see FIG. 6A).

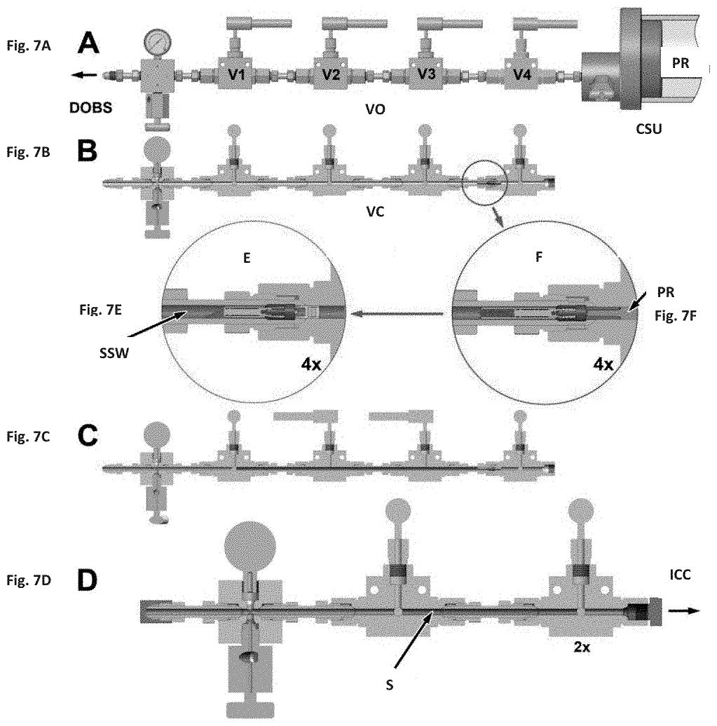

Construction of adapters for interfacing the Core Subsampling Unit with high pressure culturing hardware within WHOI, especially the High Pressure Isolation Chamber (Jannasch et al., 1982; Taylor, 1987). For obtaining cultures from the DOBS samples, a hardware interface which allow the transfer of the core sample in the form of suspended slurry into the high pressure isolation chamber (Jannasch et al., 1983). See FIG. 7. The WHOI High Pressure Isolation Chamber (HPIC) possesses internal hardware for both culture of bacteria in liquid culture and allows streaking onto the surface of solid nutrient medium for isolation of pure clones, all under pressure without decompression.

The interface will be similar in design to the universal Sample Transfer System (STS) used by the Jannasch group to transfer water samples and cultures between all of the WHOI high pressure hardware (all have the same bolt pattern allowing transfer under high pressure between two available water samplers/culture chambers, the HPIC and a High Pressure Chemostat). The end caps of STS will be different from the Jannasch system allowing the mechanical transfer of the MSC (FIG. 5) into the body of the STS via ball valve and resuspension of sediment sample with an appropriate liquid medium. The exact details of the mechanism by which the sediment samples will be resuspended are presently not firm (e.g., hydraulically expelling the sediment from the MSC with medium via a needle inside the STS, etc.) and will be a future design objective. The bolt pattern will be identical to the Jannasch STS and pressure maintained within the unit via a similar mechanism. Sample transfer in our STS, however, will not involve the crank system of the Jannasch system, but will be via a hydraulically activated floating piston or high pressure pump and ball valve assembly attached to the HPIC

Sub Core Extractor (SCE) Renamed Core Subsampling Unit (CSU)

Note: The some of the following components have had some of their names changed in later descriptions.

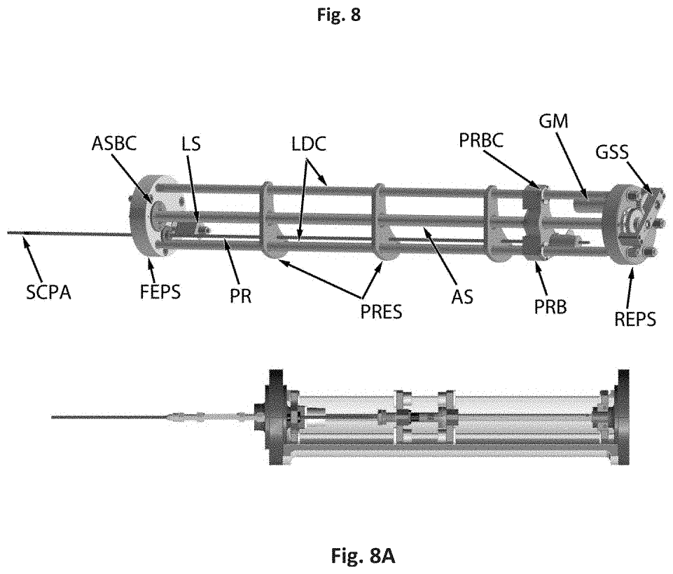

Originally I designed a pressure housing for a Sub Core Extractor (SCE) (renamed the Core Subsampling Unit (CSU) in later descriptions), which is used to remove pressurized sub samples from the Deep Ocean Benthic Sampler (DOBS). The internal configuration for the original design can be seen in FIG. 8A, (old design) along with the drawling of the new design FIG. 8B showing the internal components of the low-pressure side of the Sub Core Extractor (SCE). These changes were made as an overall method to reduce costs and enhance safety of operation of these components. By changing the design from the originally proposed method of using a Sub Core Extractor (SCE) housed in a pressure vessel, to the new design which does not require the use of a pressurized housing around the sub core extractor. So using this new design there is no longer the requirement for a pressure housing or the additional cost of the gases required to fill the pressure housing chamber. In addition these changes increase the overall safety of operation when using these components, by not having a pressurized vessel.

FIG. 8, shows the new design for the Sub Core Extractor (SCE) or (CSU) which is smaller in diameter than the originally proposed Sub Core Extractor (SCE). The length of both designs would have been the same and by reducing the overall diameter of the new design if it were to be used in a pressure housing it would have greatly reduce the cost of the housing. As an additional cost savings the Sub Core Extractor (SCE) was designed so that its parts are interchangeable with the parts found in the Deep Ocean Benthic Sampler (DOBS). This was also done because the internal workings of the DOBS are a proven design which eliminated the need for additional prototype testing. The Sub Core Extractor (SCE) has a low pressure side and a high pressure side, FIG. 8-ND, depicts the low-pressure side of the Sub Core Extractor (SCE) and is described here. It's method of operation is fairly simple, a Sub Core Probe Assembly (SCPA) which is used to extract the pressurized core from the DOBS is attached to the ends of a long slender component called the Push Rod (PR). The Push Rod (PR) is driven forward by a Gear Motor (GM) which in turn rotates an Acme Screw (AS) which drives the Push Rod Block (PRB) forward or revers depending on the direction the motors rotating. The Push Rod Block (PRB) firmly holds the Push Rod (PR) which has the Sub Core Probe Assembly (SCPA) attached to its end. As the motor is rotated in the forward direction the hole assembly advances, moving the Push Rod Block (PRB), Push Rod (PR) and Sub Core Probe Assembly (SCPA) forward into the DOBS where it extract a sub-sample. The motors then reversed pulling these components back into its starting position.

These components are held in place by the Forward End Plate Support (FEPS) and the Rear End Plate Support (REPS) which are separated by a series of four Linear Drive Columns (LDC). The forward and rear end plate supports are used to mount the gear motor and associated parts such as the Gear Shaft Support (SSG), drive gears, bearings, Limit Switches (LS) and the Acme Screw Bearing Covers (ASBC). A series of Push Rod Extractor Support's (PRES) are used to prevent the Push Rod (PR) from buckling due to forces that the Sub Core Probe Assembly (SCPA) are exposed to, when taking a pressurized sample from the DOBS.

This series of plates, Push Rod Extractor Support (PRES) follow the Push Rod (PR) as the Push Rod Block (PRB) moves forward or back keeping the push rod from buckling. The Push Rod Extractor Support's (PRES) collapse along with the Push Rod Block (PRB) as it moves forward keeping the Push Rod (PR) supported at all times. A cable is used (not shown) to pull the Push Rod Extractor Support (PRES) back as the Push Rod Block (PRB) is moved in the reverse direction, again keeping Push Rod (PR) supported to prevent buckling at all times.

The Push Rod Block (PRB) contains linear sleeve bearings which are fitted to the columns and are held in place by a Push Rod Bearing Covers (PRBC). The Push Rod Block (PRB) also supports a bronze nut which is attached to the Acme Screw (AS) used to drives the Push Rod Block (PRB) forward and back along the Acme Screw (AS). The Push Rod Block (PRB) is the terminal end support for the Push Rod (RP) as it is driven forward and back and moves the Sub Core Probe Assembly (SCPA) into the Sample Cavity (SC) of the DOBS where it extracts its sub-sample and returns this sub-sample to a pressure retaining sample chamber which is removable for later study.

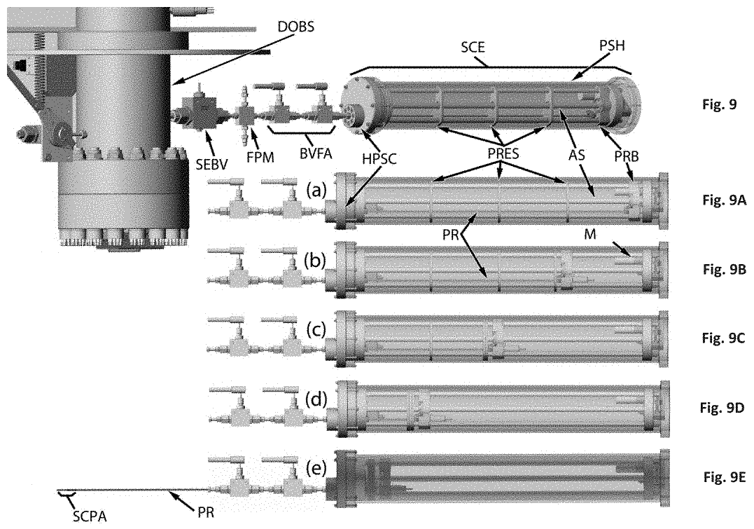

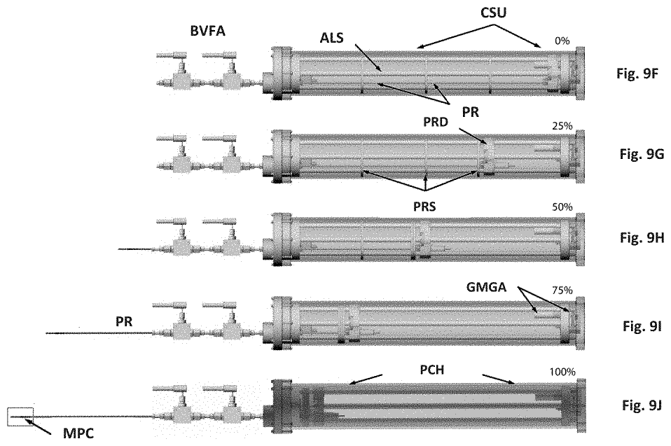

FIG. 9A-J: depicts the Sub Core Extractor (SCE) inside of a low-pressure polycarbonate safety housing (PSH) which is attached to the DOBS through a conduit made up of a series of components which make up the high pressure side of the sub core extractor assembly. The components which make up the high pressure conduit that lead into the DOBS Sample Cavity (SC) for pressurized sub sample extraction are the Sample Extraction Ball Valve (SEBV), which is a part of the DOBS and is not removable from the DOBS while pressurized. The following components which make up the rest of the conduit can be removed. They are the Fill Purge Manifolds (FPM) which supports a pressure gauge on one side and a fill purge valve on the other side. The Ball Valve Freeze Assembly (BVFA) which is used to maintain the sub-sample in a pressurized state once it has been removed from the DOBS sample cavity. In addition this Ball Valve Freeze Assembly (BVFA) is designed to maintain the pressurized sub-sample that can be removed from the assembly and brought back to the laboratory where can either be frozen using liquid nitrogen or the sub-sample can be maintained at pressure and temperature for later experimentation. The High Pressure Seal Cavity (HPSC) which separates the low-pressure side from the high pressure side of these assemblies. The rest of this figure is showing how the Acme Screw drives the Push Rod Block (PRB) forward moving the Push Rod Extractor Supports (PRES) with it as the Push Rod (PR) advances forward into the DOBS Sample Cavity (SC) (a-e). Then the motor is reversed, extracting these components back to the starting position except for Sub Core Piston Assembly (SCPA) which is deposited in between the two ball valves which make up the Ball Valve Freeze Assembly (BVFA), this will be explained in greater detail in figures to follow.

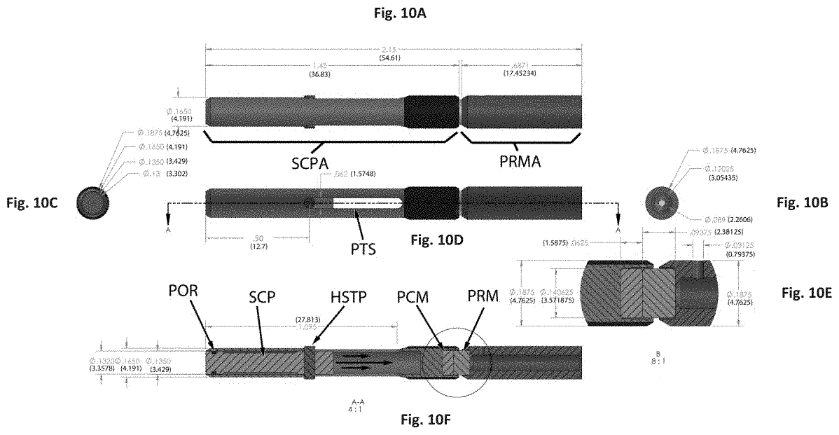

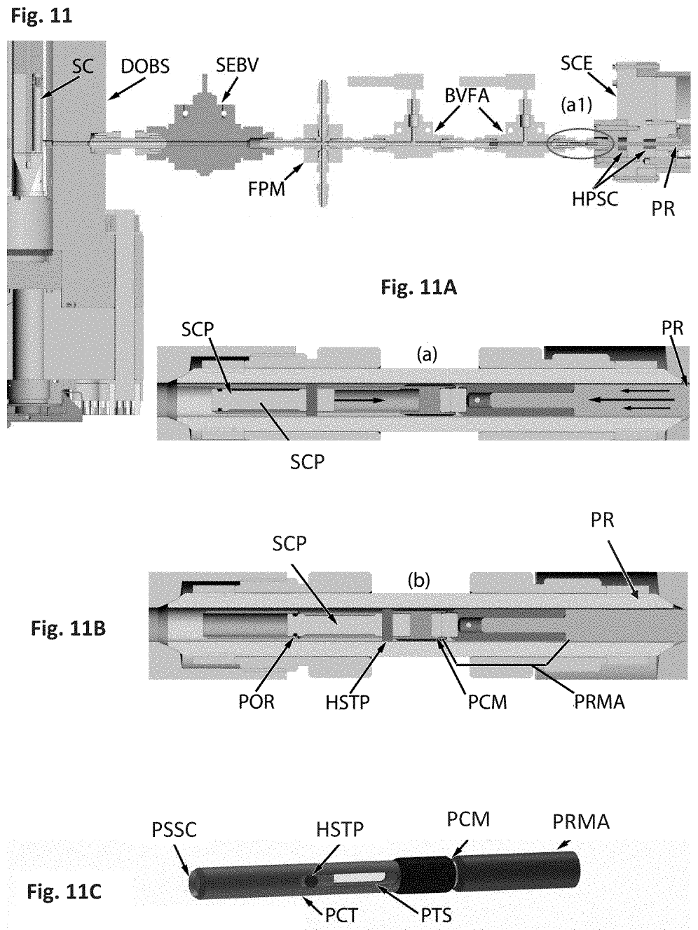

FIG. 10: shows the Sub Core Piston Assembly (SCPA). This assembly is used to extract sub samples from the DOBS Sample Cavity (SC) (see FIG. 11). The Sub Core Piston Assembly (SCPA) is made up from two subassemblies the Push Rod Magnet Assembly (PRMA) and the Sub Core Piston Assembly (SCPA). The Push Rod Magnet Assembly (PRMA) is connected to the Push Rod (PR) by a threaded connection at one end, while the opposite ends holds a cobalt samarium magnet called the Push Rod Magnet (PRM) which is used to couple the front end of these assemblies together. The front end of this assembly Sub Core Piston Assembly (SCPA) is made out of titanium or other biocompatible material and is composed of a Sub Core Piston (SCP), Piston O-Ring (POR), Hard Stop Tracking Pin (HSTP), Piston Tracking Slot (PTS) and a Piston Core Magnet (PCM) housed within a titanium sleeve or other biocompatible material which holds the sub-sample. These two assemblies can be separated from each other at the interface of the Piston Core Magnet (PCM) and Push Rod Magnet (PRM).

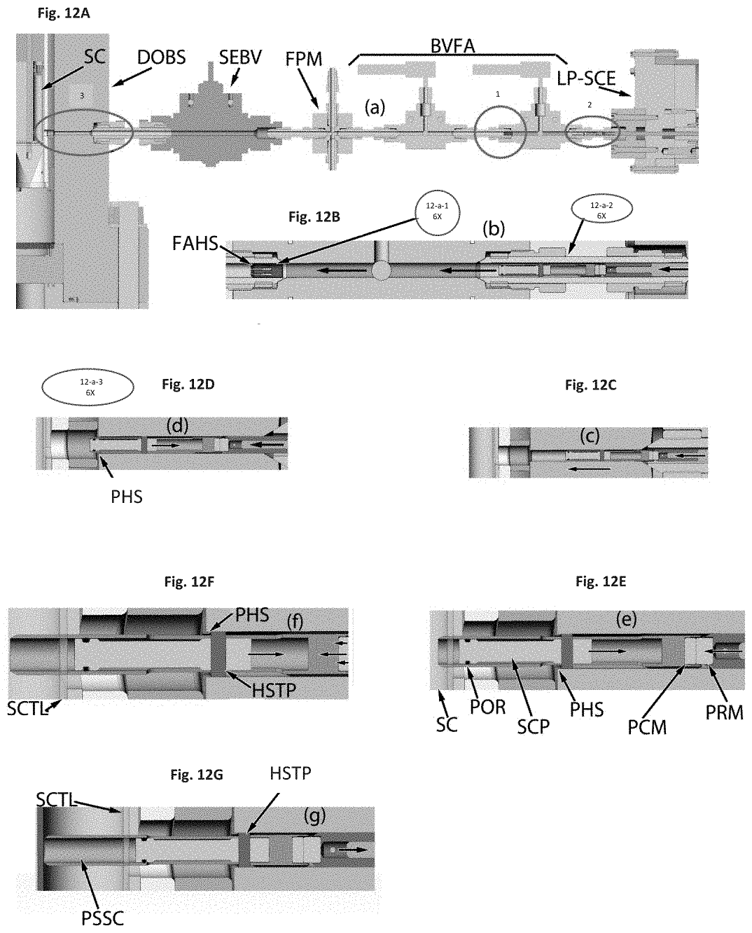

As the push rod is advanced forward the Hard Stop Tracking Pin (HSTP) hits a hard stop inside the DOBS which pushes the piston to the back of the Piston Sub Sample Cavity (PSSC) (see FIGS. 11C and 12G). This action of the piston being pushed back by the hard stop is used to help extract a sub-sample from the DOBS, Sample Cavity (SC).

FIG. 11: shows cross sectional views of the sub core piston operation. At the top of the figure is the DOBS connected to the high pressure conduit. FIG. 1A shows the location of the Sub Core Piston Assembly (SCPA) prior to pressurization of the conduit; this is the home location of the Sub Core Piston Assembly (SCPA). The fill purge manifold is used to pressurize the conduit so that the pressure in the conduit is equivalent to the pressure found inside the DOBS when it is returned from its sampling depth. Pressure equalization can be determined by noting the internal pressure of the DOBS which can be obtained via a pressure sensor and display that monitors the internal pressure of the DOBS and comparing that to the pressure gage attached to the fill purge manifolds. The conduit is pressurized using a gas booster. This conduit can either be pre-pressurized by filling the Ball Valve Freeze Assembly (BVFA) to a gas pressure higher than that found in the DOBS and then equalizing the pressure throughout the conduit or it can be pressurized while attached to the DOBS as shown in FIG. 11. FIG. 11A shows the location of Sub Core Piston (SCP) prior to sub-sample acquisition 11B shows the location of the piston after it has acquired a sub-sample. FIG. 11C shows another view of the Sub Core Piston Assembly (SCPA) not in cross section to give a better representation of how all the components work together as a unitarian hole. In this view sub core piston has been moved slightly back showing Piston Sub Sample Cavity (PSSC) inside the Piston Core Tube (PCT) and how the Hard Stop Tracking Pin (HSTP) follows the Piston Tracking Slot (PTS).

As the Push Rod (PR) moves forward (a) and the Hard Stop Tracking Pin (HSTP) hits a hard stop (not shown here, see FIG. 11A and FIG. 5J to view the hard stop) the Sub Core Piston (SCP) moves to the back of the Piston Core Tube (PCT) FIG. 11-b (b), as the sub-sample is obtained.

FIG. 12A shows the location of the Sub Core Piston Assembly (SCPA) at its home location (oval in red on the right side of the top fig.). To the left (large oval in red) is the first hard stop called the Piston Hard Stop (PHS) (see d-f it is the pink part in the drawings). This component drives the Sub Core Piston (SCP) to the rear of the Piston Sub Sample Cavity (PSSC) as it pierces the sub core tube lining or port and enters its way into the Sub Core (SC) in the DOBS. The Sub Core Piston (SCP) is used to prevent the small sample volume from leaking out of the open ends of the Piston Sub Sample Cavity (PSSC) it creates a vacuum to hold the sample in.

FIG. 12B shows the location of the second hard stop called the Freeze Assembly Hard Stop (FAHS) located in the right side of the Ball Valve Freeze Assembly (BVFA) (red circle in FIG. 12, (a). FIG. 12, (b) Show the Sub Core Piston Assembly (SCPA) to the right of the Freeze Assembly Hard Stop (FAHS) as the Push Rod (PR) is advanced forward the Sub Core Piston Assembly (SCPA) freely passes through the Freeze Assembly Hard Stop (FAHS) on its way to the Piston Hard Stop (PHS). FIG. 12, (c-f) show the motions of the advancing Sub Core Piston Assembly (SCPA) as it hits the Piston Hard Stop (PHS) driving the piston in the opposite direction as it penetrates the Sub Core Tube Lining (SCTL) port and then into the Sample Cavity (SC) where the sub-sample enters into the Piston Sub Sample Cavity (PSSC). The final in this series figure (g) shows the Push Rod (PR) and the Sub Core Piston Assembly (SCPA) being extracted from the Sample Cavity (SC) as the Gear Motor (GM) and Acme Screw (AS) is reversed to withdraw these components (any method can be used to advance and withdraw these components as those skilled in the art of design knows, so it is not limited to gear motors of acme screws).

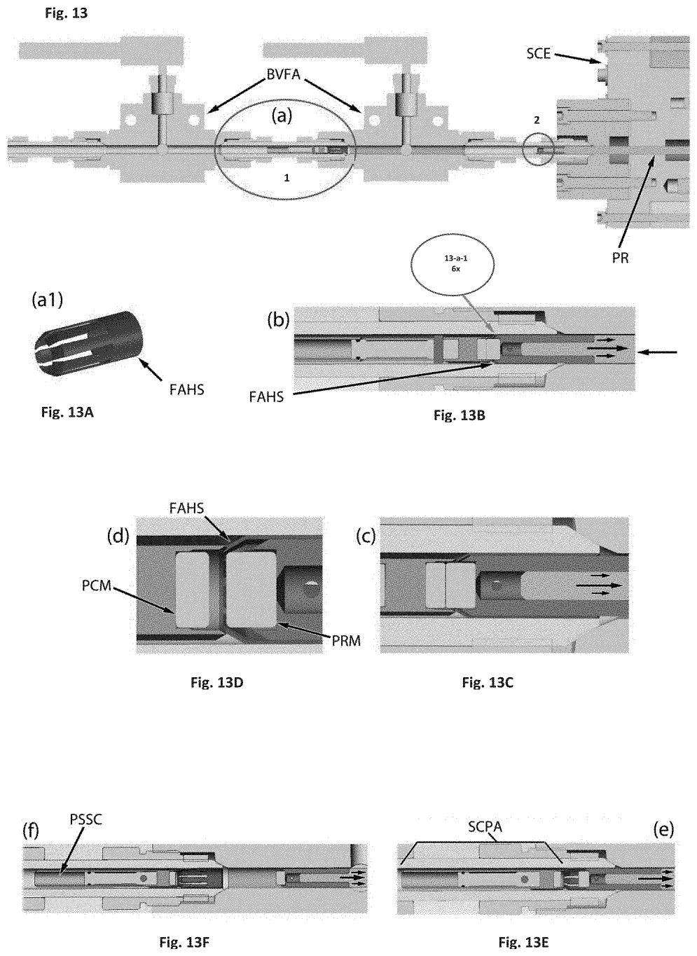

FIG. 13: shows the Ball Valve Freeze Assembly (BVFA) attached to the Sub Core Extractor (SCE) in this figure you'll notice that the Push Rod (PR) is at its home location (small circle in red) without the front portion of the Sub Core Piston Assembly (SCPA). It has been removed at the second hard stop called the Freeze Assembly Hard Stop (FAHS). FIGS. 13B-E show how the Freeze Assembly Hard Stop (FAHS) separates the front portion of the Sub Core Piston Assembly (SCPA) from its rear portion the Push Rod Magnet Assembly (PRMA) (which can be made from a magnetic stainless steel to increase magnetic flux making a stronger coupling between the two magnetic.

The Freeze Assembly Hard Stop (FAHS) shown in FIG. 13 (a1) is used to separate the front portion of the Sub Core Piston Assembly (SCPA) from its rear portion the Push Rod Magnet Assembly (PRMA). Freeze Assembly Hard Stop (FAHS) allows the sub core piston assembly to pass through in one direction, the forward direction moving towards the DOBS Sample Cavity (SC). When this assembly is pulled in the opposite direction through the Freeze Assembly Hard Stop (FAHS) it separates the Push Rod Magnet Assembly (PRMA) from the Sub Core Piston Assembly (SCPA). This locks the forward portion of the Sub Core Piston Assembly (SCPA) in between the two ball valves of the Ball Valve Freeze Assembly (BVFA) as the Push Rod (PR) is withdraw back to it home location.

At this point the two ball valves are closed sealing the forward portion of the Sub Core Piston Assembly (SCPA) with it sub-sample in between the two ball valves while maintaining the sub samples native pressure. This allows the removal of the Sub Core Piston Assembly (SCPA) from the high pressure conduit. Then the Ball Valve Freeze Assembly (BVFA) can be kept chilled and returned to the lab for further research. A new Ball Valve Freeze Assembly (BVFA) replaces the removed assembly for additional sampling.

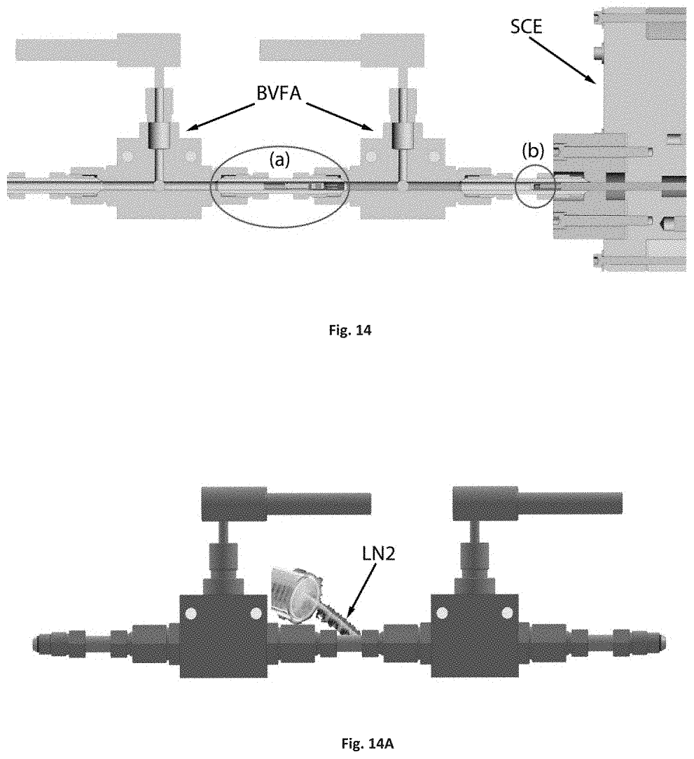

FIG. 14: (a) Depicts the Ball Valve Freeze Assembly (BVFA) still attached to the Sub Core Extractor (SCE) showing the forward portion of the Sub Core Piston Assembly (SCPA) locked in between the two ball valves at the Freeze Assembly Hard Stop (FANS).

FIG. 14 (b) shows a Piston Core Magnet Assembly (PCMA) at its home location after sub-sample extraction has occurred.

FIG. 14A shows the Ball Valve Freeze Assembly (BVFA) removed from the high pressure conduit and having liquid nitrogen being poured over the portion of the high-pressure conduit containing the sub-sample. This will allow the sub-sample to be frozen and fixed in the same state which it came up from the bottom of the ocean allowing additional molecular techniques to be used for analyzing the sample.

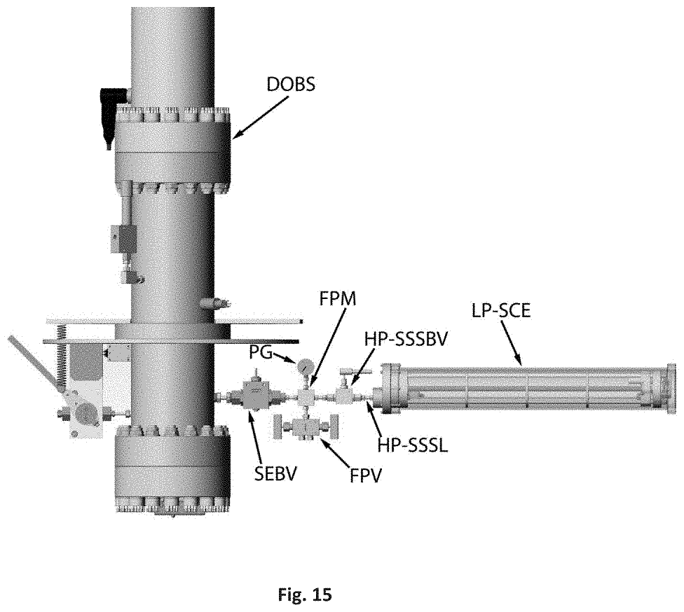

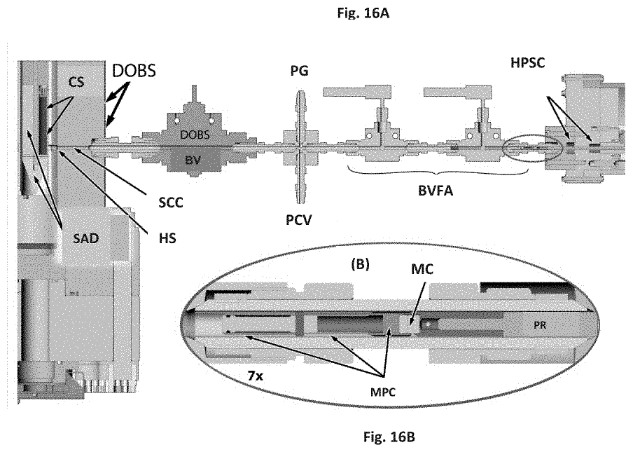

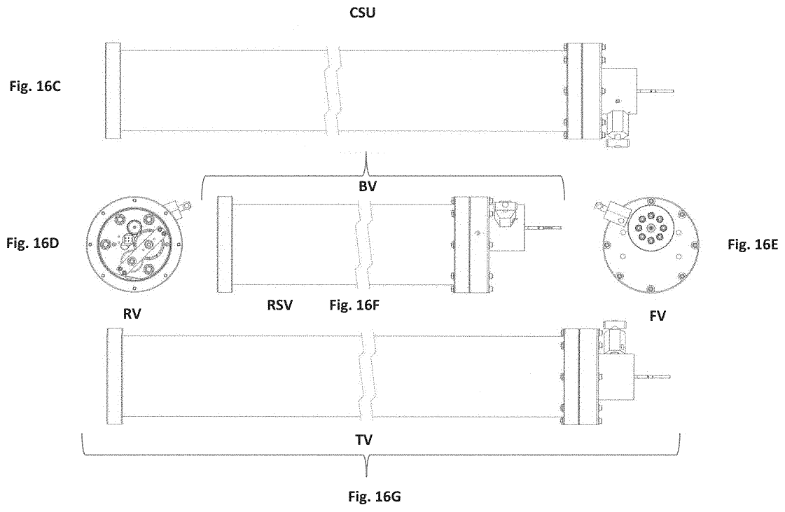

FIG. 15: depicts the DOBS connected to a similar conduit using only one ball valve. This setup will allow the extraction of a pressurized sub-sample for transfer into the hyperbaric isolation culture chamber for additional culturing experiments. The pressurized sample is maintained at its home location (see FIG. 11, (a1)) in between the High Pressure-Sub Sample Storage Ball Valve (HP-SSSBV) and the High Pressure-Sub Sample Storage Location (HP-SSSL) as shown if FIG. 15.

The High Pressure-Sub Sample Storage Ball Valve (HP-SSSBV) and the High Pressure-Sub Sample Storage Location (HP-SSSL) along with the High Pressure Seal Cavity (HPSC) can be removed from the Sub Core Extractor (SCE). Where it can be maintained at temperature and pressure until the sample's return to the laboratory for transfer to the hyperbaric isolation culture chamber were additional culturing experiments can be carried out.

The high pressure sealing side of the Sub Core Extractor (SCE) or High Pressure Seal Cavity (HPSC) was designed to except two types of seals, one which requires that the Push Rod (PR) to have a very smooth surface finish and if blemished it could compromise the pressurized transfer of the subsample. As a backup, two interchangeable methods of sealing the high and lower pressure sides of the Sub Core Extractor (SCE) will be used. One method uses a spring energized seal; which will not leak unless the Push Rod (PR) is damaged. The other method uses a cup shape packing which will work even if the Push Rod (PR) is damaged. The draw back when using this type of seal is it may leak pressure wile sub-sampling. Having a backup method was implemented in case the Push Rod (PR) (used to penetrate the seals) is damaged in handling. If one of the Push Rods are damaged i.e., by scoring or scratching the outer surface of the rod. It can be replaced or the seal type can be changed to the cup shape seal which is not affected as much by scoring or scratching the surface of the Push Rod (PR). The Push Rod (PR) is coated using a diamond chromium coating to protect them from scoring or scratching.

In addition new methods will be attempted and implemented to save on the volume of gas used to charge the DOBS. Yielding a cost saving and reducing the number of gas cylinders normally required to charge the DOBS and the amount of time needed to fill the device. Reducing the volume of gas is also inherently safer.

One of these methods that will be attempted involves the replacement of the gas in the upper pressure chamber of the DOBS with a nonconductive silicone fluid. This can be done without changing the operation of the DOBS by simply changing the seals between the upper and lower pressure chambers of the DOBS with high pressure T shape bidirectional seals. This will allow the upper pressure housing of the DOBS to be pressurized to a greater pressure then the sampling depth, eliminating the need for pressure compensation of the fluid filled vessel. For depth greater than 5000 meters a compressibility studies will have to be conducted to determine if there is enough volume of gas in the lower pressure chamber of the DOBS to flush the snubbing fluid from the snubbing fluid chamber. This chamber is the contamination free interface between the inner and outer environments.

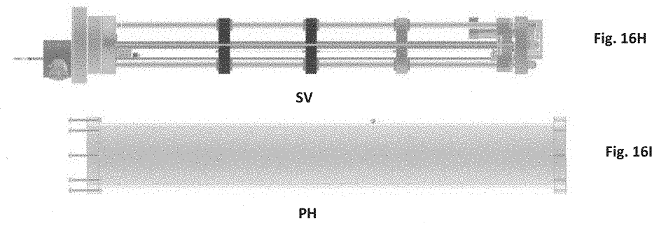

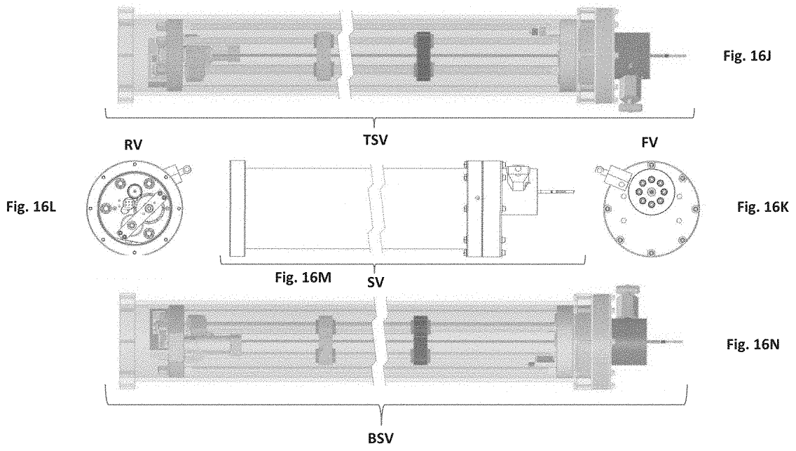

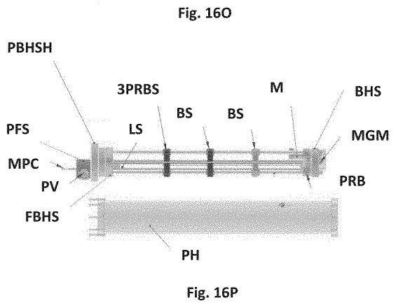

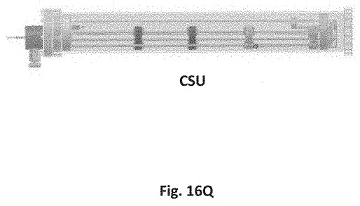

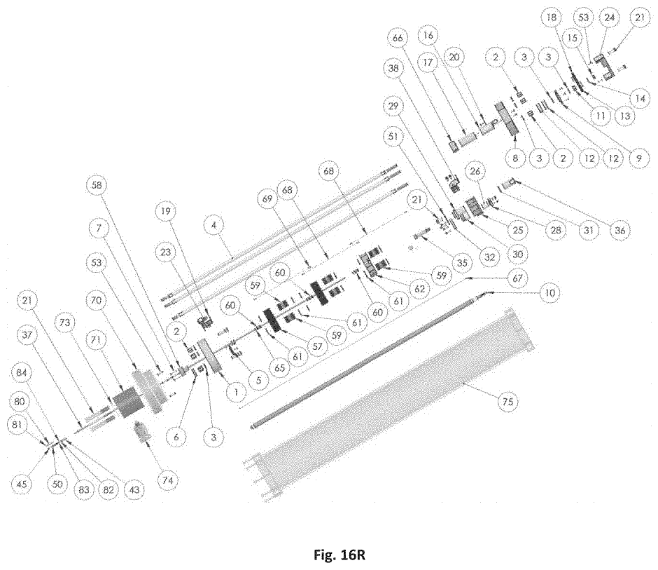

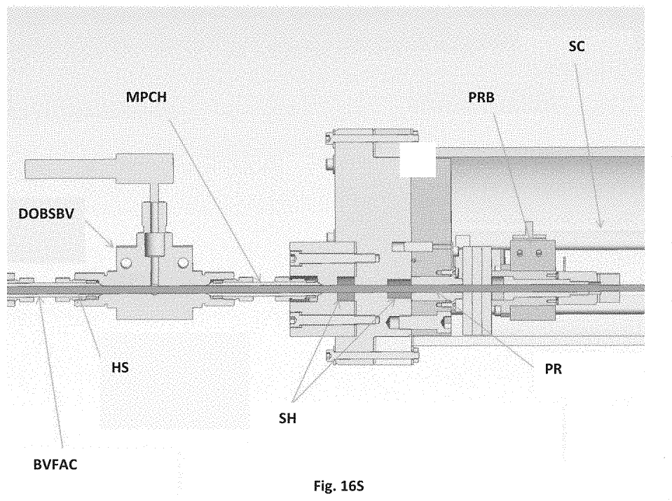

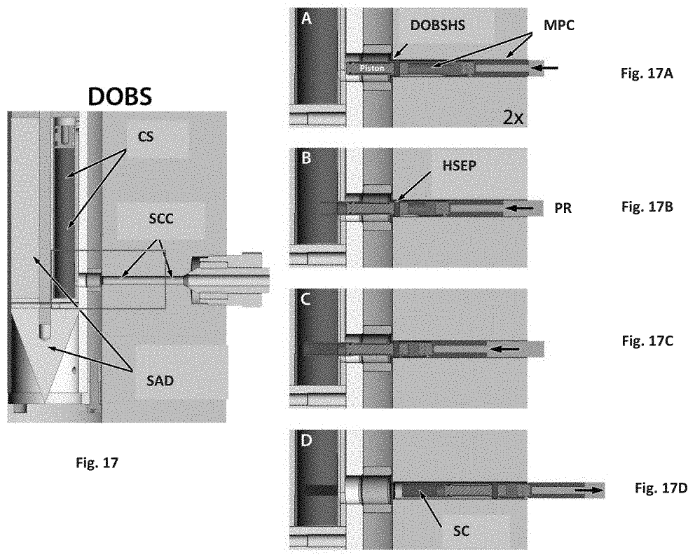

Use of the Core Subsampling Unit (CSU) was called the Sub Core Extractor (SCE): The basic concept behind the CSU is to procure “subsamples” at chosen depth horizons within the collected deep-sea core using a Miniature Piston Corer (MPC) that penetrates the core sample from the side (FIG. 16A,). The CSU is connected to the DOBS via high pressure tubing that interconnect 3 ball valves, a larger DOBS Ball Valve leading into the interior of the DOBS and two smaller valves composing a Ball Valve Freezing Assembly (BVFA). During the sub-coring operation a Sub-coring Channel is aligned with the Core Sample and the depth horizon to be subsampled brought into position by moving the DOBS Sample Acquisition Device (SAD) into desired vertical alignment with the Sub-coring Channel (FIG. 16-A). The high pressure conduiting connecting the DOBS to the CSU is pre-charged with helium (or other gas or gas mixture) to the in situ pressure of the helium atmosphere (or other gas or gas mixture) within DOBS and the two atmospheres merged by opening the 3 ball valves, which results in an open channel between the CSU and the DOBS, allowing access to the Core Sample.

As shown in FIG. 16A, the MPC (inset) is affixed to a Pushrod via two very strong cobalt samarium magnets. The Pushrod is sealed against the high pressure helium atmosphere within the DOBS and interconnecting conduiting (up to 600 ATM, 608 bars, 60.8 MPa) by two proprietary High Pressure Seals (FIG. 16A) that allows the interior of the CSU to be maintained at atmospheric pressure (1 ATM, 0.101 MPa), greatly reducing the weight and expense of the CSU. The high pressure atmosphere within DOBS and the high pressure conduiting (up to 600 ATM, 608 bars, 60.8 MPa), however, subjects the Pushrod to ˜200 lbs. of force along its axis, requiring that Pushrod Supports be distributed along the length of the CSU to prevent buckling (FIG. 9A-E).

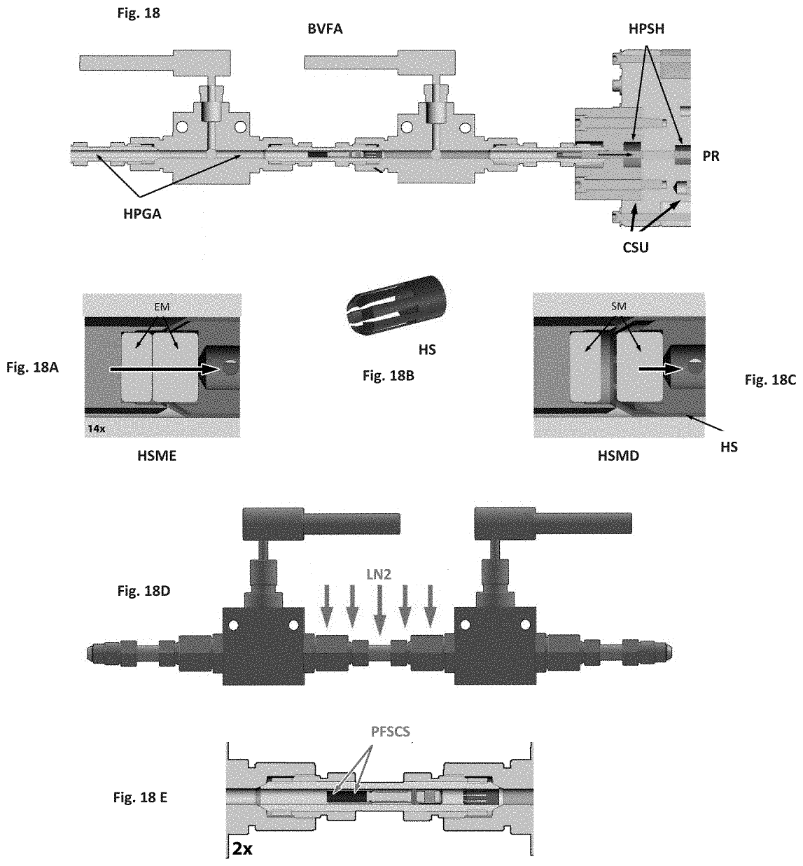

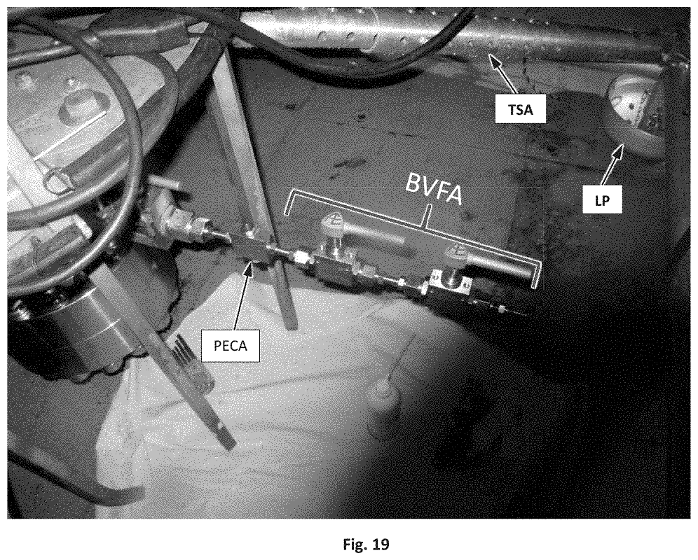

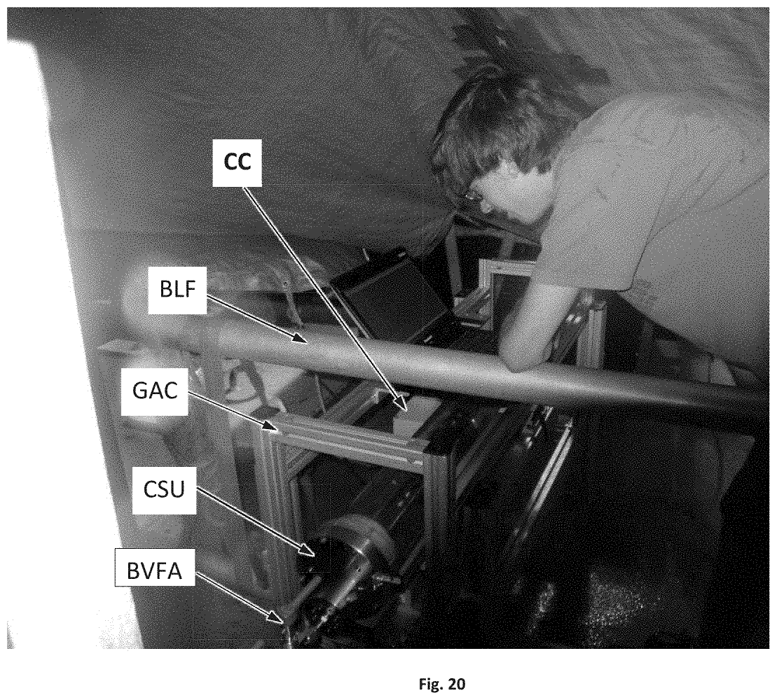

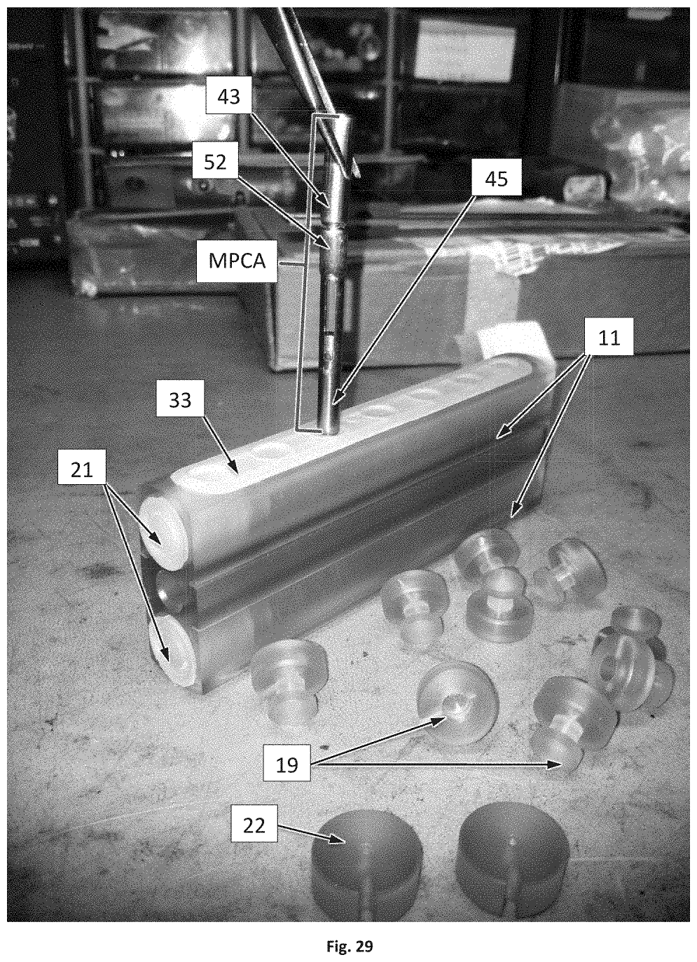

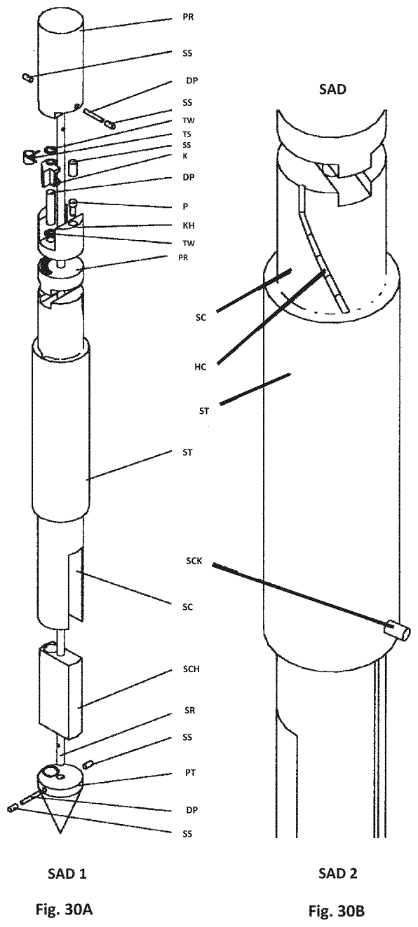

To take a core sub-sample from the Core Sample within the DOBS, a microprocessor controlled Motor & Gear Drive Assembly within the CSU is activated (FIG. 9F [0%]). A gear driven Lead Screw propels the Pushrod Drive and Pushrod through the high pressure seals and into the high pressure conduiting and open ball valves (inset sequence) until the MPC reaches the Core Sample within DOBS and procures a sub-core. The position of the Pushrod Drive is known at all times by a microprocessor and stopped/reversed when the sub-core is taken. An illustration of the sub-coring operation is shown in FIGS. 5J-M and 17A-D. The liner of the DOBS core unit possesses a slot that is sealed with a silicone rubber seal that possesses a series of “X-cuts” along its axis. When the MPC intersects the silicone seal a given X-cut yields FIG. 29, items (33, 45) in figure, allowing penetration of the MPC core edge into DOBS Core Sample (FIGS. 5J-M). A Hardstop Engagement Pin that is press fit into the MPC piston (FIG. 9A, inset, FIG. 5K,) “engages” a Hardstop within the DOBS (FIG. 5J-M), arresting movement of the MPC Piston while the MPC core liner penetrates into the Core Sample (FIG. 5C). The MPC is then retracted by the CSU, withdrawing the Sub-core (FIG. 5M); the X-cut closing, “resealing” the Core Sample. As the Pushrod is withdrawn back into the CSU the Pushrod Supports, which are each tethered to premeasured lengths of cable, are gradually and evenly repositioned as illustrated in FIG. 9A to again prevent buckling of the Pushrod when retracted into the CSU. When the MPC is withdrawn up into the BVFA it engages a Hardstop (FIG. 18A-C, HS which pulls the two magnets apart (FIG. 18, FIG. 18 A-C) depositing the MPC between the two ball valves. The DOBS Ball Valve & BVFA ball valves are closed, isolating the core sub-sample from DOBS & the CSU. The BVFA is then disengaged from DOBS and CSU as shown in FIG. 18E, the interior still being maintained at in situ pressure. Liquid nitrogen is then poured over the central section of the BVFA (FIG. 18D, blue arrows), freezing the pressurized core sub-sample (2× inset) FIG. 18E.

Once the core is solidly frozen the BVFA is decompressed, the MPC removed, and the frozen core ejected into a glass grinder tube (the surface of the MPC is quickly warmed to thaw a surface micro-layer of the frozen core so that it is releasable from the MPC). RNAlater is added to the grinder tube and the sub-core dispersed by the grinder tube pestle so that the instant the sediment sample is thawed the nucleic acids, including mRNA are instantly preserved, a critical capability for gene function studies made possible by the DOBS concept. The preserved sample is then extracted for DNA, RNA, mRNA according to the desired analyses to be conducted (i.e., for phylogenetic or gene functions studies).

The same sub-coring operation is followed for procurement of sample for subsequent biogeochemical analyses (e.g., CO₂, CH₄, H₂S, etc.). If sensitivity permits, a fraction of the frozen core might be split, half for molecular analysis, half for biogeochemical analysis (e.g., GC-MS, etc.).

For culture work the freezing step is omitted. The sub-core can be decompressed and core contents dispensed into a dilution medium for resuspension and subsequent culture either at atmospheric pressure (1 ATM, 0.101 MPa) or in situ hydrostatic pressure in various culture media. It will also be possible to inject dilution medium into the BVFA to resuspend the sediment for subsequent transfer into a high pressure isolation chamber available at the WHOI laboratory should one wish to avoid decompression during the microbial culture/isolation process. The new method can be seen in FIG. 7A-D.

BVFA's are fabricated so that the DOBS Core Sample can be subsampled at multiple depth horizons (paired samples as close to one another as possible), providing a 5-point depth profile of the microbiology and biogeochemistry in the retrieved DOBS core (correspondence between molecular & biogeochemical analyses will be matched by interpolation).

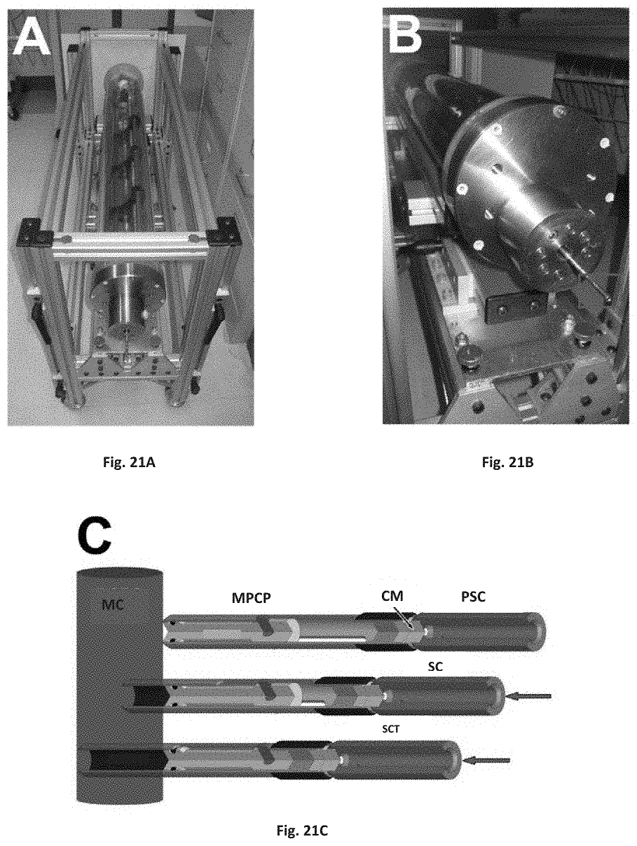

Goniometer cart for the alignment of the CSU to the DOBS: The Goniometer Alignment Cart (GAC) (FIGS. 5G, 20, 21A, and 22) is a device that allows proper alignment of CSU (FIG. 5G-H) with the DOBS while on the deck of the ship. The cart has been designed so that we can adjust for the slope of the ship's deck, the height of the CSU relative to the height of the entrance port into the DOBS. It can also be adjusted horizontally, vertically and to any tilt angle required having proper alignment for taking a subsample from the DOBS using the CSU.

Microprocessor Control of the Deep Ocean Benthic Sampler (DOBS):

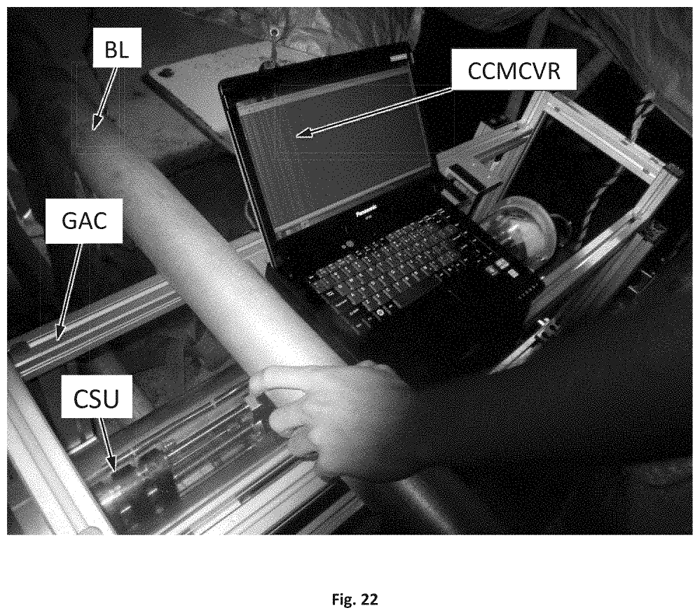

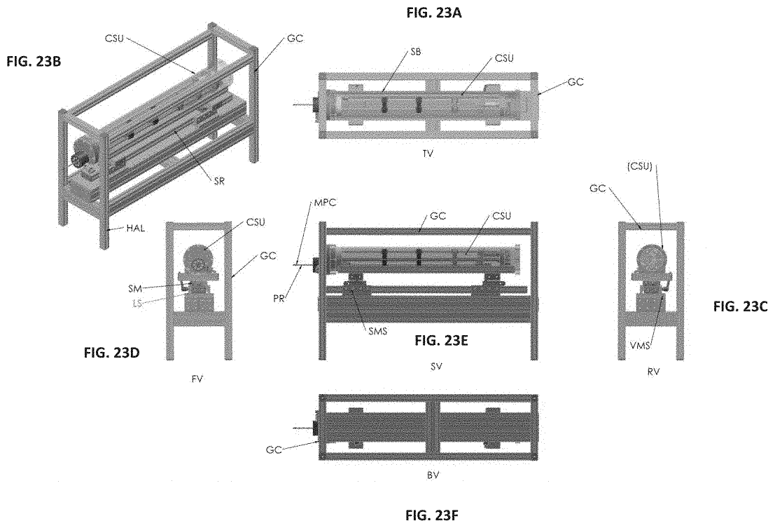

A microprocessor (FIG. 22) will be used with the DOBS to provide more accurate control of the sample acquisition device (SAD probe). The microprocessor will also allow precise control of the DOBS door for repetitive sampling task. Each time the DOBS is prepared for a dive to retrieve a sediment sample; the door to the entrance of the DOBS needs to be opened to gain axis to the SAD probe for cleaning. The microprocessor will be programmed so we can control not only the door but also the vertical location of the SAD probe, so we can gain axis to any portion of the sample cavity.

DOBS Sub Sea Lander:

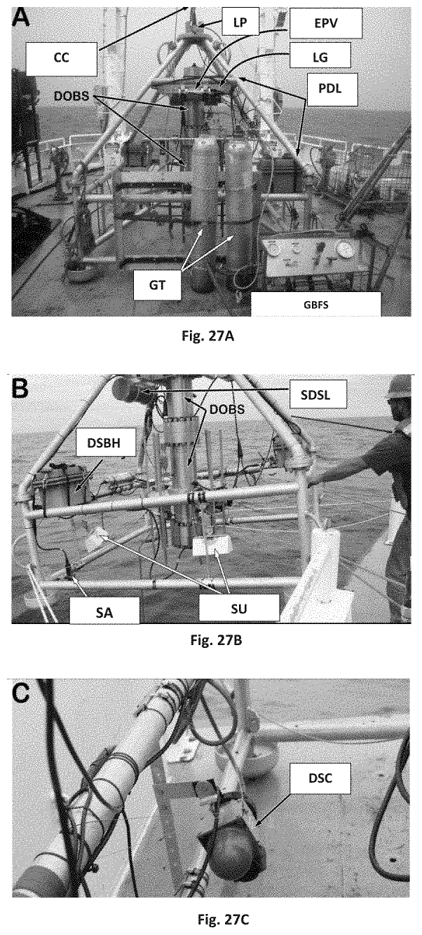

The DOBS lander (FIG. 6, 24, 27A-C) is a pyramidal aluminum structure PDL that possesses an articulated gimbal LG so that the DOBS sampler is maintained vertical at all times, even if irregularities in the sea floor causes the lander itself to be slightly off-vertical. The base of the pyramidal structure (Schedule 40 aluminum pipe) is 2.28 m (˜7.5 ft.) on a side and rises to an apex 2.74 m (˜9.0 ft.) off the sea floor, not including the cable termination structure. The lander possesses 4 inverted dome-like landing pads that permit the structure to “slide” on the sediment surface if needed rather than digging in and capsizing upon landing. The positioning of the landing pads can be manually adjusted (50 cm; ˜20″) for different types of terrain. The landing pads can be perforated with multiple holes to make an easier release from the sediment. The lander frame incorporates ample space for additional instrumentation including cameras DSC (FIG. 27C), strobes SU (FIG. 27B), battery packs DSBH, instrumentation pressure vessels, the Synchronous Digital Subscriber Line (SDSL) data-link package and more. The Lander has 4 removable telescopic arms which are used to hold the DOBS centered in the lander for transport and when taking a subsample using the Goniometer Cart and the CSU. These telescopic arms are removed for deployment. The Gimbal used to hold the DOBS in the lander can be made in many different configurations, show in these drawings it is round. In the actual designed lander the gimbal is square which reduced cost in manufacturing.

The DOBS lander is deployed using two conductor torque balanced cable (diameter 1.73 cm, 0.68″) troll wire CC that could readily handle the combined weight of the DOBS (907 kg; ˜2000 lb.) and Lander (227 kg; ˜500 lb.). The cable was connected to the apex of the lander via a “Load Pin,” LP a strain gauge device that allowed real-time transmission of the weight of the assembly for detection of when the lander “touched down” on the sediment surface.

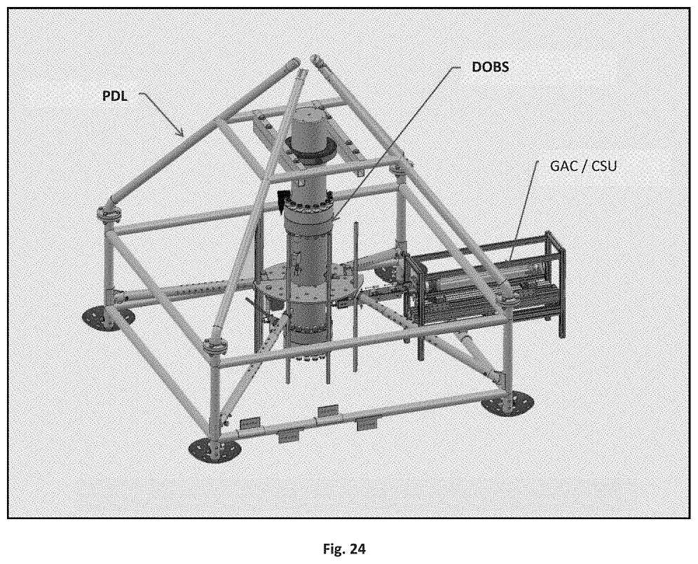

The lander (FIG. 24,) will hold the DOBS in an articulated mount so that DOBS will be vertical even if the lander is at a modest angle on the sea floor. Incorporated onto the lander will be support frame called the Goniometer Cart that will cradle the CSU in alignment with the DOBS for the sub-coring operations outlined above. The Lander frame also holds a removable tank rack, shown with tanks GT, used for filling the DOBS with high pressure gas through a gas booster GBFS FIG. 27A. Sensor package for deployment of the DOBS to the sea floor: FIG. 27, A-C. The deployment sensors implemented on the DOBS lander will consist of 1) a video link & lighting, 2) a load sensing pin that will transmit when the lander touches down on the sea floor, 3) two sonar altimeters SA to signal when the DOBS lander is close to the sea floor. Data will be transmitted up the 0.68″ conducting cable via the Ethernet SDSL data-link.

Core Subsampling Unit (CSU) or Sub Core Extractor (SCE): FIGS. 3A, 5G-H, 9, 11, 15, 16C-S, 20. The Core Subsampling Unit (CSU) is also outfitted with a microprocessor and encoder so we can control the length of stroke of the Push Rod (PR) into and out of the DOBS Sample Cavity (SC) FIG. 22.

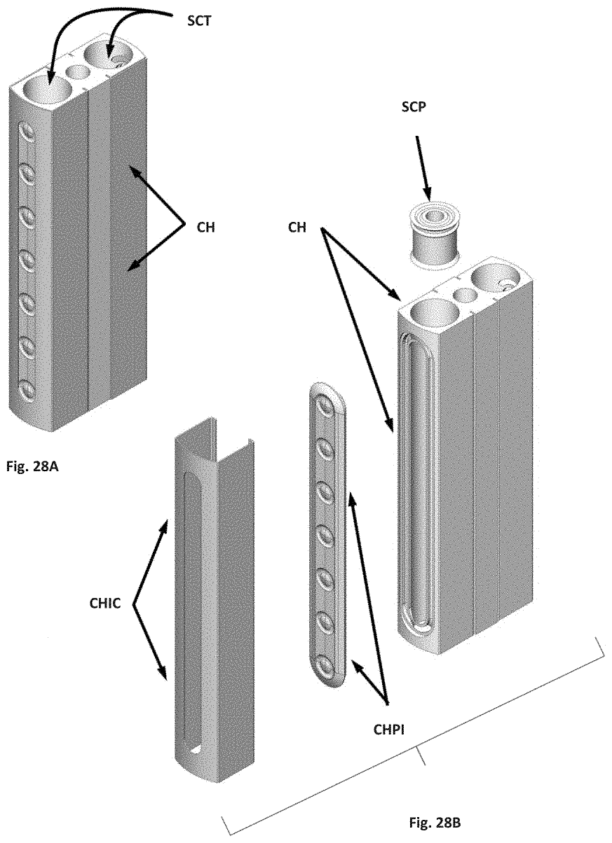

Sample Cavity: FIG. 28A, 28-B, 29, shows the Sample Cavity which is located in the Sample Aquasistion Device (SAD) probe of the DOBS. It is made from a biocompatable material which can be sterlized. This version has two sample tubes each having a portion which allows horizontally taken subsamples vertical through the sample tube of the sample cavity. These sample tubes can have inserts placed in them (a plastic tube which can be remover from the top or bottom of the sample cavity) with a tape, film or other insert placed on the inner or outer surface which can be penetrated by a subsampling probe. The design shown here has a silicone elastomer insert with preperfrated sealed ports this silicone insert is placed in a type of tong and groove cavity (but can be placed in or on and attached by using any method for those skilled in the art) within the sample cavity. The silicone insert is called the Silicone Slip Cover. The Sample Cavity can has an interlocking cover to protect the insert/film or tape from damage such as peeling or delaminating. It also prevents the insert from pulling out of the Sample Cavity. The Sample Cavity can be a single chambered cavity with only one large sample tube and a single larger diameter piston as will be shown later with the description of the SAD Probe.

Silicone Slip Cover also called Sub Core Tube Liner, Silicone Rubber Insert: shown in FIG. 28B, 29, these parts are used to allows a probe or subsampling device such as the Miniature Piston Core (MPC) to penetrate into the Sample Tube of the Sample Cavity. In the design used here a specially designed port which can withstand the weight and forces which occur wile taking a vertical core sample. The preperfrated ports will not leak after horizontal subsamples are taken. The ports can be reentered without lose of sediment. The ports are designed differently then the types found it the food industry. These ports work in a the opposite direction keeping things in, while the other types of food understory ports are for squeezing things out and resealing. The figures show the Sample Cavity with the two sample tubes and silicone piston (which can be made of other materials).

Silicone Piston: FIG. 28B, 29 shows a silicone piston(SCP) which was used because it will not interfere with the ports. When made from harder materials and a film was used to take subsamples through the harder piston could interfere with the film placed on the inner or outer surface of the sample cavity. A hard material piston could peel or puncture the film used to make the subsample port slip cover. Each of the two sample tube has a piston which starts at the bottom of the sample cavity and as the sample cavity moves down into the sediment the piston maintains it position taking an undisturbed core sample. The piston was designed to create a vacuum to maintain the sample integrity as it moves thorough the sample tube. The piston has two wipers one on the top and bottom of the piston and two bulbus rims which act as o rings maintaining the vacuum as the piston pass by each port. These o ring are placed just below the upper wiper and above the lower wiper. When the Sample Cavity is removed from the SAD probe the pistons stay in the top of the Sample Cavity so as to maintain the sediment within the sample tube upon removal from the SAD probe. FIG. 29 shows the some of the components used to maintain the piston centered within the sample cavity. The Si Puller Pads #19 are snapped into the top of the pistons and a cable or rod is attached to it by a pin or set screw. The Si Piston Centering Plugs #22 are to keep the cable or rod pulling straight up and not at an angle as the SAD probe moves into the sediment (as well be discussed later in the section on the SAD probe).

Miniature Piston Corer magnetic coupling: FIG. 29, While testing the subsampling operation using some deep-sea clay sentiments, it was discovered that the forces required to remove the Miniature Piston Corer from the Sample Core could be far greater than what we had encountered in previous testing; sometimes resulting in premature disengagement of the coupling magnets between the Miniature Piston Corer and Pushrod, which could be a serious issue. To eliminate this potential issue, we dramatically increased the strength of the magnetic coupling by using much stronger Neodymium magnets, increasing the coupling strength from ˜186 grams (0.41 lbs.) to ˜952 grams (2.1 lbs.). In addition a change of the material used to make the RNA Mag Probe Tip (#43 in the pdf drawing of the exploded view of the Core Subsampling Unit (CSU)) to increase the magnetic flux of the coupling, increasing the holding power of the magnets. The material used is a 430FR magnetic stainless steel, a disk of this material was also added to the back end of the Miniature Piston Corer #52 also known as the Subsampling Piston. This completely solved the premature disengagement issue #45.

Enhancement permitting larger diameter cores to be taken: The design of a 3.81 cm (1 W) diameter piston core tube option has been added for the study of gas hydrate and petrochemical sampling. DOBS sample probes can be exchanged while on the ship. This was previously not possible without the changes made to the Piston Corer Mechanism. This new enhancement will allow a wider and 5.1 cm (2″) longer cores [total elongated core tube length 15.24 cm (6″)] to be acquired.

Sample Acquisition Device (SAD probe) Without Piston Puller:

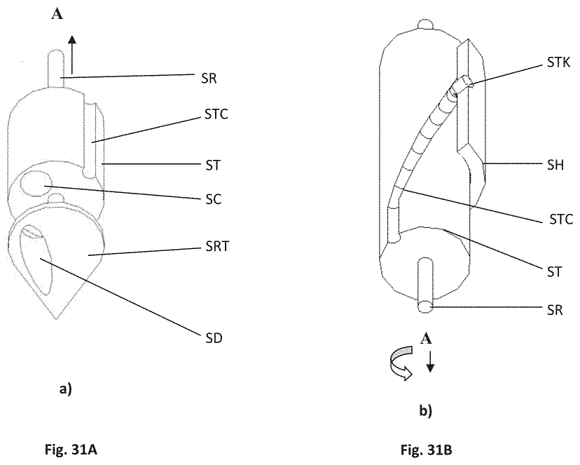

Sample Acquisition Device: The Sample Acquisition device (SAD) consists of a Sample Rod (SR) and a Sample Tube (ST) that slide out of a Sampler Housing (SH) during the acquiring of the sample and slides back into the Sampler Housing during the retrieving operation. For clarity, I have separated SAD in three parts for the purpose of explaining how this subassembly works, see FIG. 31A and 31B (a, b). FIG. 31A(a), shows the tip of the SAD. The Sample Door (SD) of the Sample Rod Tip (SRT) and the Sample Cavity (SC) are aligned in the initial position before acquiring the sample. The acquiring of the sample takes place by pushing the SAD into the sand to a pre-established depth, were the sand fills the Sample Cavity. To retain the sample in the Sample Cavity, the Sample Tube has to rotate relative to the Sample Rod therefore, the Sample Door and the Sample Cavity will be in an offset position and the sample will be trapped inside the Sample Cavity.

The relative rotation between the Sample Rod and the Sample Tube is being achieved by creating a channel, see Figure FIG. 31A and 31B, in the Sample Tube that runs along the Sample Tube axis. The length of the straight section is proportional to the pre-designed depth at which the sample will be taken. The Sample Tube Key (STK), (see FIG. 31B, runs through the Sample Tube Channel (STC) at all times and it is mounted into the Sampler Housing (SH) which is fixed. By pushing down on the Sample Rod-Sample Tube assembly there will be no relative motion as long as the Sample Tube Key slides in the straight section of the Sample Channel (SC). Once the Sample Tube Key engages the helicoidal section of the Sample Tube Channel, the Sample Tube will start rotate relative to the Sample Rod and a solid section of the Sample Rod Tip will block the entrance into the Sample Cavity. The length of the helicoidal section of the Sample Channel has to be chosen such that the Sample Cavity is completely closed when the Sample Tube Key reaches the upper end of the helicoidal section of the Sample Tube Channel. The helix angle of the Sample Tube Channel has to be chosen such that the mechanism created is backdriveable and prevents locking between the Sample Tube and the Sampler Housing.

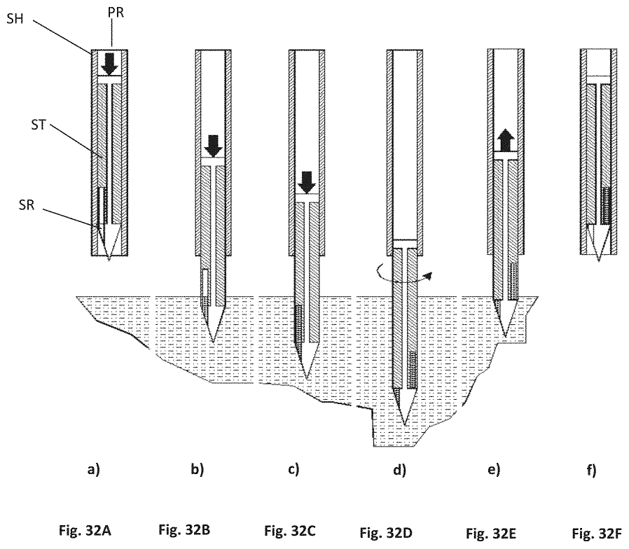

Another feature of this type of mechanism, not described in this section, refers to a retractable key between the Sample Rod and the Sampler Housing. During the descend and the acquiring of the sample and also, a second retractable key between the Sample Rod and The Sample Tube that will become active after the Sample Cavity was closed. At this point both keys are envisioned as simple, one way, spring loaded retractable devices that will also allow manual reset of the SAD. FIG. 32, describes the phases of acquiring the benthic sample using the SAD. FIG. 32A is the initial position where the descend of the SAD starts. FIGS. 32B and 32C show the actual acquiring of the sample. The sand fills the Sample Cavity completely due to the vertical force applied by the Pushrod. In FIG. 32D, the closing of the Sample Cavity takes place.

FIG. 32E depicts the retraction of the SAD and FIG. 32(f) shows SAD back in the initial position.

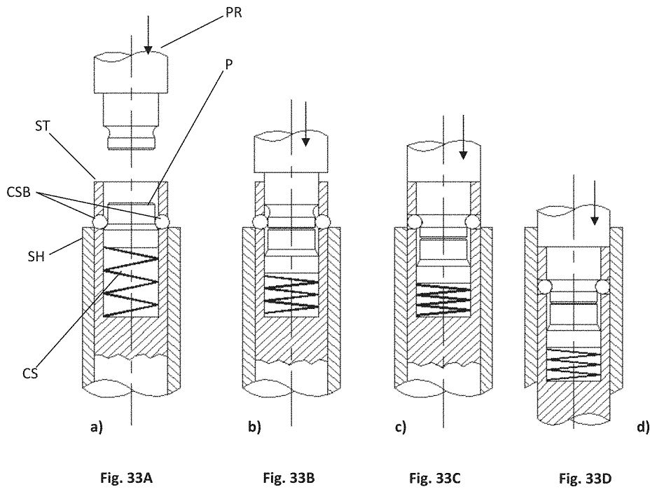

Quick Connect-Disconnect mechanism: The Quick Connect-Disconnect mechanism couples the Pushrod with the Sample Acquisition Device (SAD) during the descending of the Pushrod and also decouples the two parts after the SAD has been fully retracted into the Sampler Housing. FIGS. 33A-D describes the sequence of coupling the Pushrod with the SAD.

In FIG. 33A the Plunger is being Preloaded by the Compression Spring and pushes out the Calibrated Steel Balls. In this position, the Sample Tube rests at the top of the Sampler Housing in the initial position. This position also corresponds with the final position of the SAD after the acquiring of the sample.

In FIG. 33B the Plunger continues its descend and starts pushing the preloaded Plunger downward. The recess in the Plunger reaches the position in which the balls are free to move in and the plunger hard stops on the Sample Tube, see FIG. 33(c). This will allow the Sample Tube to descend along with the Pushrod. The Calibrated Steel Balls are now coupling the Pushrod with the Sample Tube and it will stay that way whether the pushrod moves up or down inside the Sample Tube, FIG. 33D.

The Pushrod will decouple from the Sample Tube only when the Calibrated Steel Balls are free to move outward, pushed by the preloaded Plunger, and that position corresponds with the Sample Tube being in the initial position, FIG. 33A.

Description of Sample Acquisition Device (SAD): See Drawings 30A,30B, SAD 1, SAD 2. (The assembly is not limited to the method described here, other methods can be used to make this device as those skilled in the art of design).

The Sample Acquisition Device (SAD) collects an undisturbed sediments, power, liquid or surly sample. The Sample Tip/Door secures the Sample into the Sample Cavity and the Sampler is then retrieved back into the Sample Chamber. The figures SAD1, SAD2, show how this can be achieved by a simple push-pull action using a single linear actuator.

The Sampler Tube houses all the components of the Sample Acquisition Device (SAD) (see Drawings 30A, 30B, SAD 1, SAD 2). The Penetrating Tip (PT) is attached to the Sampler Rod (SR) at one end using a ⅛″ Dowell Pin (DP) held in place by two setscrews (SS). The Push Rod (PR) is mounted to the Sample Rod at its other end in the same manner (a ⅛″ Dowell Pin held in place by two setscrews). All the other components are mounted along the Sampler Rod between the Penetrating Tip and the Push Rod. The Sample Cavity (SC) is located inside a slot into the Sample Cam (SC) such that in the initial position, the actual Sample Cavity is aligned with the Sample Door (SD) of the Penetrating Tip.

The Sampler Retainer (SR) is keyed on top of the Sampler Cam. The Key Housing (KH) sits on top of the Sample Retainer such that the spring loaded Key (K) is keyed into the Sampler Tube (ST) slot and the spring loaded Plunger (P) is positioned 90° relative to the deepest point of the Sampler Retainer cam slot. In the initial position, the Plunger should be preloaded against the flat surface of the Sample Retainer.

The Key pivots about a 9/32″ Dowell Pin and is preloaded with a Torsional Spring (TS). There are two Teflon Washers (TW) added on both sides of the Key to reduce friction and prevent locking (not shown in the drawing). The Key is also free to rotate about its axis in counter-clockwise direction while it hard stops in the clockwise direction.

At the base of the Sampler Tube there is a Sampler Cam Key (SCK) screwed into the wall of the Sample Tube. The Sampler Cam Key is a commercial, stainless steel, spring loaded plunger. Its tip acts as a key and rides inside the Sampler Cam slot at all times.

The Push Rod has a threaded hole at its very end for hook up to a rod that will be pushed downward manually to simulate the action of a linear actuator upon the Sample Acquisition Device (SAD).

Sequence of Operation: SAD (FIG. 30A, 30B)

In the initial position, the Sample Acquisition Device sits above the sediment at a predetermined distance.

The operator (simulate the action of a linear actuator) pushes the Push Rod down. The Sampler should penetrate the sediment and continue it's descend with the Sample Cavity in open position until the Sample Cavity is filled with sediment. In parallel, the Sampler Cam Key is riding inside the straight section of the Sampler Cam slot. Next, the Sampler Cam Key engages the helical section of the Sampler Cam Slot. The Sampler Cam starts rotating counter-clockwise while the Push Rod, the Key Housing, the Sampler Rod and the Penetrating Tip are being held steady rotationally by the torsionally spring-loaded Key. This motion causes the closing of the Sample Cavity, which in turn traps the sediment sample inside the Sample Cavity. At the end of the rotational motion of the Sample Cam, the Plunger will pop-in inside the Sampler Retainer slot, locking rotationally the Sampler Cam with the Sampler Rod, Push Rod, Key Housing and the Penetrating Tip in the clockwise direction. When the Sampler Cam Key reaches the end of the Sampler Cam slot, the downward motion stops and the retrieving operation starts.

The operator will start pulling up on the rod coupled to the Push Rod. The Sampler Cam Key will force the Sampler Cam to rotate in the clockwise direction and along with it, the Push Rod, Penetrating Tip, Key Housing and Sampler Rod which are now coupled together in the clockwise direction by the Plunger.

The elements that were locked rotationally in the counter-clockwise direction during the downward motion are now allowed to rotate clockwise. The rotationally spring loaded Key will pivot counter-clockwise, rotate out of the linear slot and ride against the inside wall of the Sampler Tube.

The sequence is completed when the Sampler reaches the initial position. The only difference now is that the Sample Cavity is closed and the Sample Rod, Penetrating Tip, Push Rod and Key Housing are offset 90° rotationally.

To reset the mechanism, the operator must rotate the Push Rod in the clockwise direction 270° until the Key pops back into the Sampler Tube slot.

Not all mechanisms of the SAD probe can be seen from the drawings when viewed from in two dimensions. An example the Ramp of Plunger Ramp (PR) cannot be seen from the drawings.

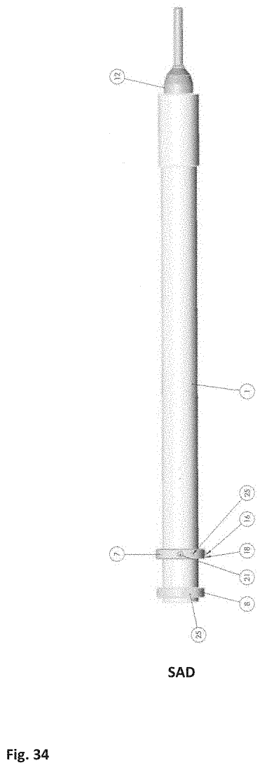

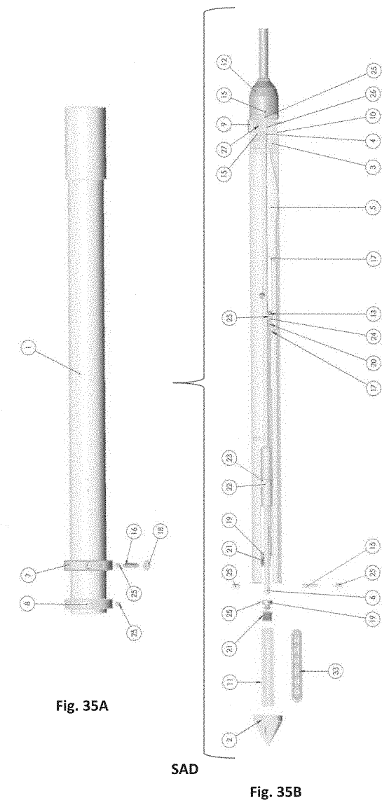

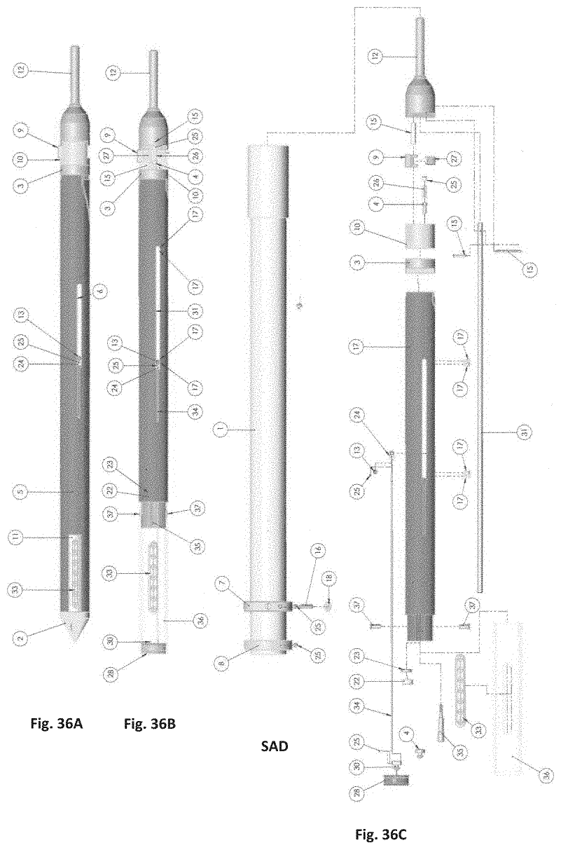

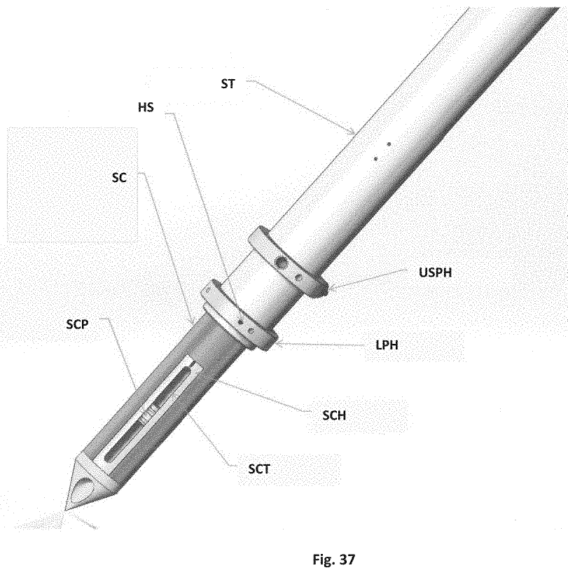

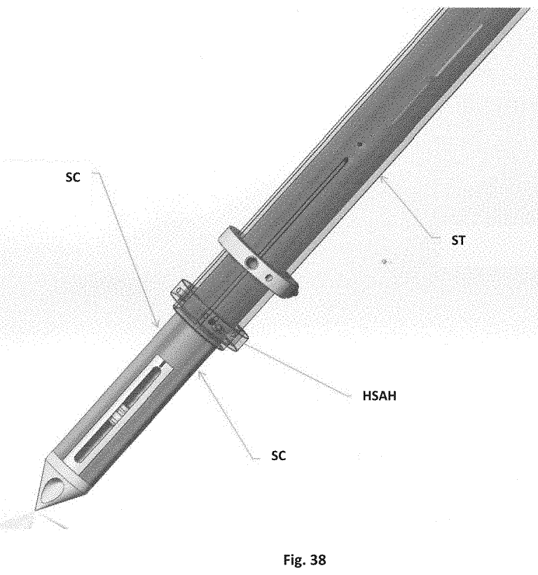

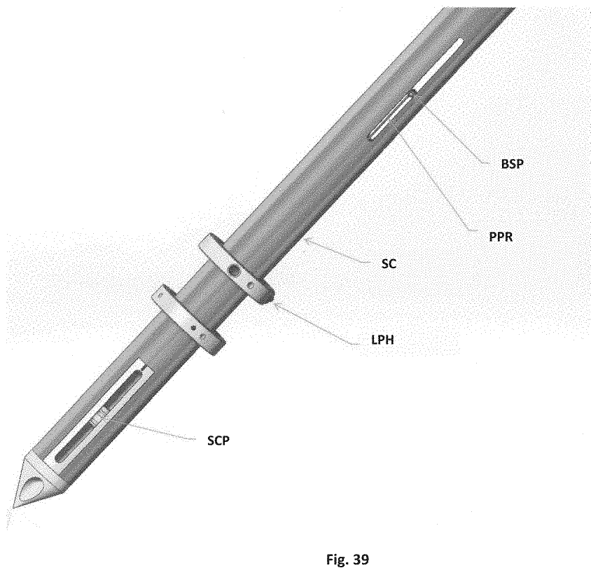

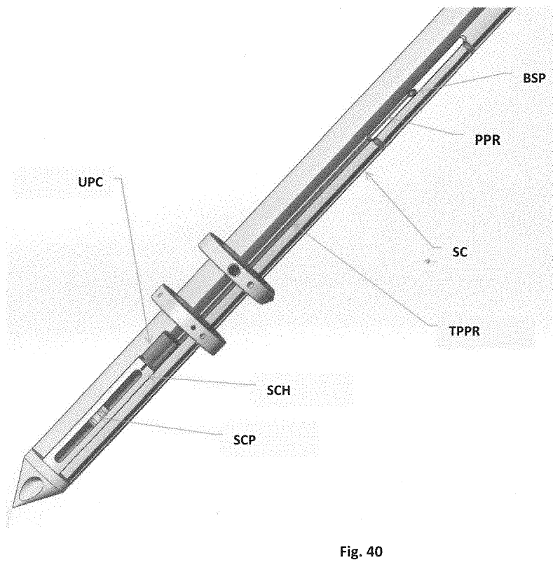

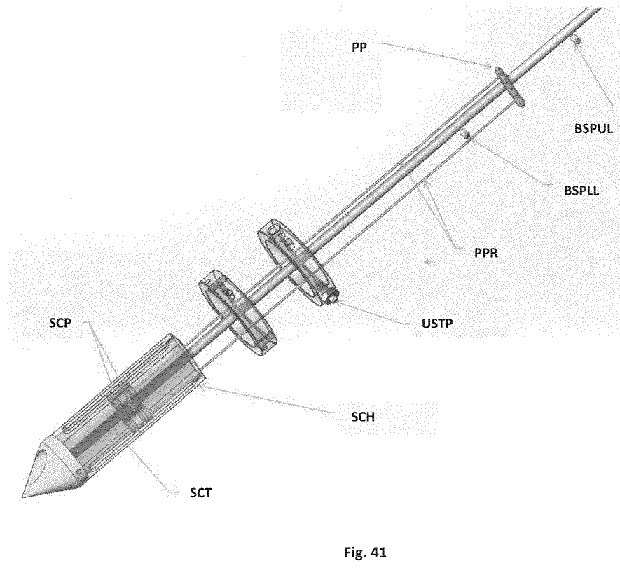

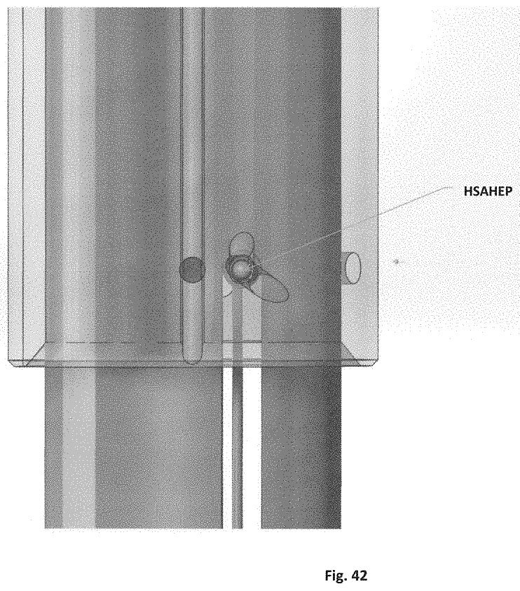

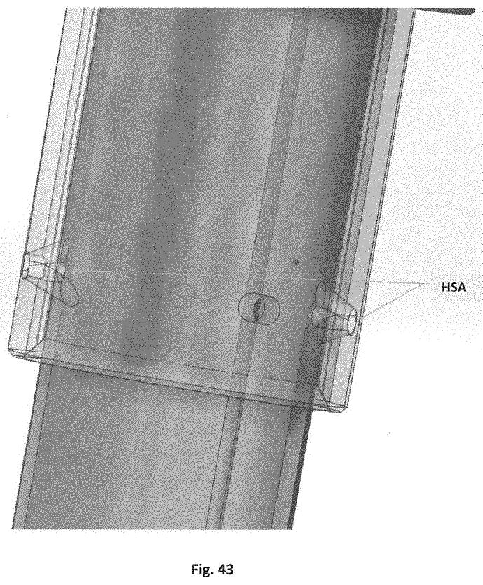

The SAD Probe With Piston Puller Added: (See Attached Drawing Set FIGS. 34-43)

To take an undisturbed sample a piston #21 or 28 is used to reduce the motion of the sample as it moves vertically into the Sample Cavities/Sample Tube #11, 36. The Piston #21, 28 is not pulled as the name implies, instead it keeps the Piston #21, 28 stationary as the Sample Cam #5 moves through the Sampler Tube #1. This is accomplished by modifying the Sample Cam #5 and the Sampler Tube #1. The Sampler Cam #5 had an off set slot cut into the side of it. The length of the slot is based on the length of piston stroke. A longer the Sample Tube or Sample Cavity the longer the slot needs to be. The slot can expose the Sampler Rod #6 or 31 but it is not necessary for it to be exposed for proper operation. The Sampler Rod #6 or 31, if exposed can be used to center the Piston Puller #24, keeping it horizontal and tracking as it is displaced up and down through the slot. The Piston Puller #24 has two Pin Spring Plungers #13, inserted one on each side. These are used to control the start and stop of the piston travel (other controls can be used in place of the Pin Spring Plungers such as a solenoid or other method and it can be triggered from the outside of the Sampler Tube #5 the same for the location and type of the hard stops used i.e. other methods can be used in place of the Pin Spring Plungers). The piston puller has two rods #34 or rod/cables combination, screw, pined #25 or other method, into the bottom right and left side of its two lobes projected from the main body of the Piston Puller #24. These rods #34 are attached to the pistons #21 at the opposite end and as the Sample Cam #5 moves down into the medium to be sampled the pistons when triggered are displaced as the Piston Puller #24 moves in the slot. The triggers are set based on the depth of the sample to be taken and when to sample starts to enter the Sample Cavity #11, 36. They are controlled by the length of the helicoidal section of the Sample Channel in the Sample Cam #5 and a set of hard stops located on the inner wall of the Sample Tube (not shown) and the length of the slot. One or Two Ball Spring Plungers #17 located at the top and bottom of the slot in the Sampler Cam #5 which is used to pause the Piston Puller #24. When the hard stop is reached the Pin Spring Plungers #17 extends into the hard stop located in the inner wall of the Sampler Tube #1. This action locks the Piston Puller #24 inside the Sampler Tube #1 as the Sample Cam moves down inside the Sampler Tube #1. This action keeps the piston #21, 28 stationary as the Sample Cam #5 moves into the sediment. When the bottom of the helicoidal section of the Sample Tube Channel reaches the end of its helix this frees the Pin Spring Plungers #17 from their hard stops; as the end of the Sample Cam #5 rotation coincides with a ramp on the inner wall of the Sampler Tube #1 which allows the Pin Spring Plungers #17 to be freed allowing the piston to now move with the Sampler Cam #5 down into the sediment and retract back up into its starting position. The upper Pin Spring Plunger #17 then locks the Piston Puller #24 at the top of the Slot. If this upper lock false the sample can be lost depending on the type of material being sampled. So a Rod/Cable combination can be used. Having the lower portion of the Rod #34 replaced with a section of cable with a length equal to the length of the Sample Cavity that way if the lock false the Rod cannot push out the sample because the cable portion will not exert any force on to the Piston. A telescopic rod can be used in place of the Rod/Cable design.

This Piston Puller mechanism will work using a single or double piston design for that matter any number of pistons can used if the diameter allows for it. By exchanging different designed Sampler Cams different size samples can be taken. In addition by changing the design of the Sampler Rod #6 so as to except the larger Sample Cavity both types of Sample Cavities can be used. I made a Sampler Rod from #31, 35, from two sections in which I can replace one section for the larger Sample Cavity with another section that works with the duel Sample Cavity.

Compressibility Apparatus:

Compressibility Study of a Gas or Gas Mixture

The need to study organisms that exist in extreme environments as those found in deep-sea hydrothermal vents, cold water seeps and the abyssal plans are becoming increasingly important. Extremophiles are forms of bacteria, yeast fungi, Archaea and other organisms that live in these extreme environments.

These organisms are producing a variety of novel biopharmaceuticals, enzymes, small molecular weight and secondary metabolite chemical compounds. Along with their interesting DNA and genome information that are becoming increasingly beneficial to our industrial society.

Research into marine microbial ecology and the biodiversity of extreme environments is a promising area of study but is greatly restricted by the absence of affective sampling methodology. These restrictions include the ability to collect uncontaminated undisturbed samples and maintain the sample under ambient pressure and have the capability to manipulate this material in absence of decompression. In the design of the deep-sea sampling system, several unknown variables became a factor for the technology to become reality. First, the need to know specific molar volume of gases when compressed to extreme pressures (>600 atmospheres) and seconds, the gases used to create the internal atmospheric environments of the sampling system and its concentration.

These questions arise due to the manner of operation in which the sampling system retrieves uncontaminated undisturbed samples while maintaining the native environment of the sampled material.

To collect uncontaminated samples we must prevent the sampling probe from contacting the seawater during deployment and descent to the ocean bottom. This was accomplished by creating a controllable interface between the sampling chamber that contained a sterile sampling probe and the deep-sea outer environment. The interface consisted of a small-segmented tube connected together to the bottom entrance of the sample chamber. This tube is filled with a snubbing fluid (incompressible fluid), which is maintained in the tube by an end cap. This fluid is expelled upon reaching the desired sampling depth and replaced by a gaseous medium, which was contained inside the sample chamber during deployment and descent to the sampling location. To understand how these components work together to acquire an uncontaminated undisturbed sample a description of the operational characteristics of the sampling system and its method of operation was described above.

The Operational Characteristics of the Sampling System for the Extraction of Uncontaminated Samples:

The sampling system consists of three chambers that can be independently isolated from each other. They are connected and aligned vertically, one above the other. The top chamber is the motor housing which is in pneumatic communication with the sample chamber below its. This housing contains the drive mechanisms for opening the entrance of the sample chamber and deployment of the sample acquisition device (SAD). The sample chamber contains the SAD probe. This chamber can be removed from the other two chambers after a sample has been acquired for transport back to the laboratory for further study of the material inside. The third chamber or lid chamber is connected to the bottom entrance of the sample chamber and is in pneumatic and hydraulic communication with the sample chamber. It contains a series of cleaning devices used to wipe the SAD probe clean of debris as the probe is retracted back into the sample chamber after acquiring a sample. This lid chamber is the controllable interface between the entrance of the sample chamber and that of the deep-sea outer environment. It is filled with incompressible fluid called a snubbing fluid.

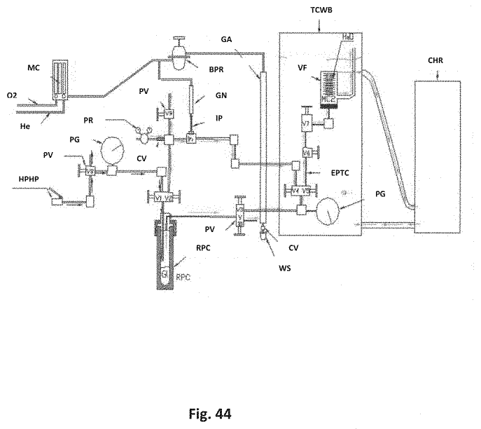

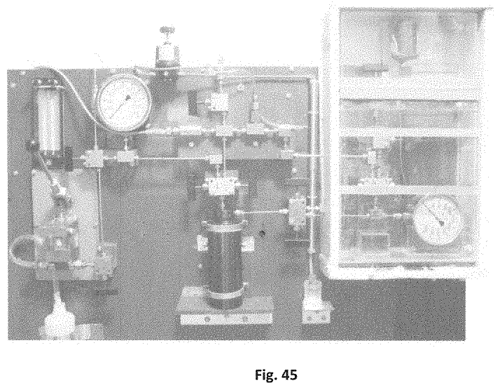

The DOBS uses gas to do work at the bottom of the ocean. When depths are greater than 600 atm the Idea Gas Laws no longer work to calculate the volume of gas needed to expel the snubbing fluid from the snubbing fluid chamber. There are no equations of state that work to calculate the super compressibility of the gas at that depth. The only way to figure out this problem is to use a device called the Barnett Apparatus or a better method, designed by me for this work called the Compressibility Apparatus see FIG. 44, 45. It is used to calculate a correction factor for the Idea Gas Laws.

The solution was to determine the compressibility factor by empirical methods. I designed a simple experiment that would determine the compressibility of any gas or gas mixture of interest. This can be done by taking a small length of high-pressure tubing say 15 cm with an inner diameter of from 0.3175 cm to 0.15875 cm. At each end attached are two-way valve the bottom connected to a high-pressure hand pump with an accurate pressure gauge and reservoir pressure cylinder. The valve on top in turn would be fed into an upside-down volumetric flask filled with distilled water. This flask would also have an exit to allow the displaced water to leave the flask. This flask would need to be about 800 times the volume of the piece of tubing used as the pressure vessel. The system could be heated or chilled to the temperature of interest. We fill the reservoir pressure cylinder with a gas or gases to be tested. Using hand pump we can compress the gas by hydraulically introducing glycerol into the reservoir pressure cylinder. Which will displace the test gas from the reservoir pressure cylinder into the piece of high-pressure tubing. When the desired pressure is reached as seen on a pressure gauge, the system is given time to reach a temperature equilibrium. Once occurred, the desired pressure and temperature has been reached, the bottom valve can be closed and the top valve can be opened slowly allowing the compressed gas to empty into the water filled flask as the water is displaced and the system is allowed to come to equilibrium the new decompressed volume of gas can be read directly from the volumetric cylinder.

We need to determine the total inner volume of our test vessel. To this volume we need to consider the stress and deformations in the pressure vessel. With this information we could calculate the actual compressibility factor for the gas being tested.

I have built this test device and used it to test the actual compressibility factor of the Oxy-helium mixture intended to be use.

Compressibility Apparatus

This picture shows the experimental apparatus for determining the compressibility of the Oxy-Helium gas mixture. Starting from the lower left-hand side of the picture showing: 1) Glycerol Reservoir (white bottle), above that; 2) hand operated high-pressure pump, above to the right; 3) Purge Valve V8, to the right and above; 4) Pressure Gauge, to the rights and down; 5) Valves V1, V2, moving downwards; 6) Reservoir Pressure Cylinder (RPC), moving right; 7) Valves V3 and Purge Valve V10, moving right; 8) Pressure Gauge, moving upwards; 9) Valves V4, V5, between V5 and below valve V6; 10) Experimental Pressure Test Cylinder (EPTC) above this is; 11) Valve V6, and directly above is valve V7 which is a metering valve, connect to V7 is, 12) Volumetric Flask for measuring volume of decompressed gas; 13) Water Bath which contains valves V4-V7. 15) A Recalculating chiller/heater not shown here is connected to the insulated water bath 13. On the top center is; 15) Purge Valve V9, below to left; 16) Inlet check valve to helium supply, to the right; 17) Oxy-Helium Inlet port.

Deep Ocean Benthic Sampler (DOBS) possesses a unique capability to the fields of deep sea microbial ecology and natural products biotechnology, the ability to obtain a contamination-free benthic boundary layer sediment core samples and preserve in situ conditions of pressure and temperature upon retrieval to the ship.

FIG. 1, The DOBS was designed by Dr. Richard Sheryll at Cyclops Research & Development, Inc. NY, N.Y.

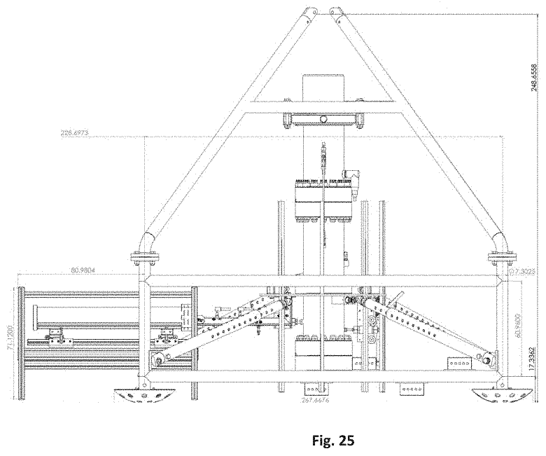

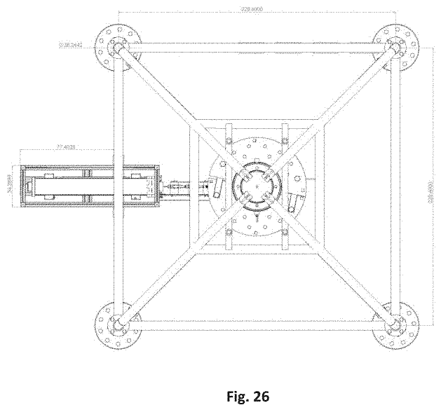

FIGS. 6, 24-27 Lander Designed by Dr. Richard Sheryll at the American Museum of Natural History, NY, N.Y.

FIG. 8, 9, 16, 20-23, The Core Sub-Sampling Unit (CSU) and Goniometer Cart Designed by Dr. Richard Sheryll at the American Museum of Natural History, NY, N.Y.

Broader Impacts

Availability of DOBS to Scientific Community. Biological diversity of marine organisms, especially of microbes found in the deep-sea, such as deep-sea hydrothermal vents, deep-sea cold seeps, but also the understudied abyssal plains holds great potential for natural products discovery and applied biotechnology. General cultivation independent diversity assessments based on the universal taxonomic marker molecule 16S rRNA have revealed a vast diversity of microorganisms. However, for the most part the physiology and metabolic abilities of these organisms remain unknown. This is mainly due to the fact that only a small fraction (<1%) of these microbes can be successfully cultivated in the laboratory, severely limiting our understanding of the ecological role and metabolic potential of these organisms. This is particularly relevant for the deep-sea, where organisms exist that are adapted to the in situ conditions, including high pressures and low temperatures. This prevents many, if not most microorganisms from these environments from being cultured in the laboratory, suggesting that we have only scratched the surface of the metabolic potential and the extent of physiological diversity of the microbial communities inhabiting these environments. Using its innovative design and methodology, DOBS will allow access to the microbes from these environments by being able to preserve in situ conditions, enabling their cultivation and thus the application of genomic and postgenomic techniques. These microbes may represent a rich reservoir of so far untapped biodiversity with obvious implications for bioprospecting. In addition, DOBS will provide extremely useful in sampling gas- and gas-hydrate bearing sediments. By maintaining in situ conditions the distribution and activity of microbes can be directly correlated with the concentration of volatile and unstable compounds, such as gas hydrates, providing novel insights into the microbial biogeochemistry of these habitats. Gaining a better understanding into the role that microbes play in affecting hydrate stability and dissolution is of great relevance. Finally, the technology behind DOBS will be made available to the scientific community by Cyclops Research and Development, Inc.

Introduction: Sampling Deep Sea Microbial Biosphere

A significant fraction of the microbial biosphere exists at elevated hydrostatic pressure (up to 110 Mpa; 1086 atm) and low temperatures, yet an understanding of microbial adaptation to these conditions, particularly pressure, is limited (e.g., Wang et. al., 2008). Though recent advances in molecular biology is beginning to address the problem it remains unclear whether adaptation to the piezosphere results from changes in a few genes, broader modification of the genome or effected mainly via regulatory processes (e.g., Simonato et. al., 2006). What is required to become a piezophile is an interesting unanswered question. Most pure clone piezophiles under study have been subjected to decompression at some time during their isolation, based on studies by Yayanos & Dietz, 1983, suggesting that piezophiles still possessing some ability to grow at normal atmospheric pressure would survive decompression and with obligate piezophiles, the quasi-first order lethal effects due to decompression is slow enough that isolates can be obtained if decompression times are minimized (˜90% loss of viability of an obligate piezophile when decompressed for 5 hr). Jannasch & Wirsen, 1984 obtained non-obligate piezophiles from the deep oceanic water column in the absence of decompression (Jannasch, et. al., 1982). Later deep-sea microbial ecology studies began to show large discrepancies between deep sediments 16S rRNA clone libraries and isolates obtained in the laboratory from the same source (e.g., Parkes, et. al., 2009; Frye et. al., 2008). On the other hand, members of enrichment cultures obtained from undecompressed deep-sea surficial sediment inocula and cultured at high pressure for several enrichment cycles did correspond to the gene library generated from the source sediment; identical inocula cultivated at sea surface pressures did not (Yanagibayashi et. al., 1999). From the perspective of obtaining bacterial clones that are at all representative of the organisms residing in deep sediments it is becoming clear that procurement and culture must be effected at the pressures

From a biogeochemical standpoint, hydrostatic pressure can also dramatically influence chemical gradients within microbial ecosystems, particularly in environments where metabolic, geothermal or hydrocarbon seep mechanisms result in elevated gaseous inputs (e.g., carbon dioxide, methane, other hydrocarbon gases, hydrogen sulfide) are driven into solution by pressure. Preservation of sediment samples from the deep oceanic seep environments is a particular challenge in that the time between sampling and retrieval can be hours & changes in pressure, temperature can result in substantial out gassing that destroys the structural and microbial integrity of the retrieved sediment sample.

Technology developed in the laboratory of R. Sheryll, the Deep Ocean Benthic Sampler (DOBS) possesses a capability that is unique to the fields of deep sea microbial ecology and natural products biotechnology, the ability to obtain a contamination-free core and preserve in situ conditions of pressure and temperature upon retrieval to the ship. By application of the Core Sub-Sampling Unit (CSU) mechanisms for obtaining multiple sub-cores at various depth horizons within the retrieved core samples, in the absence of decompression, permits in concert a) accurate assessment of the gaseous (e.g., hydrocarbons) & chemical (e.g., bicarbonate, hydrogen sulfide, etc.) gradients within the core without being disturbed by the “homogenizing” out-gassing that typically occurs in such samples when collected by conventional coring operations, b) the phylogenetic (DNA, ribosomal RNA, [rRNA]), functional (messenger RNA, [mRNA]) molecular study and culture of the resident microbiota using high pressure isolation culture chamber and chemostat available within the Woods Hole Oceanographic Institution (WHOI) and c) procurement of sediment samples for subsequent isolation of pure clones in the absence of decompression.

In the grant we proposed to develop DOBS into a routine instrument that can be used by the oceanographic community to obtain undisturbed sediment cores maintained under in situ conditions for biogeochemical and microbiological analyses. Specifically we will address the following objectives:

The invention is not limited to the particular embodiments described and depicted herein, rather only to the following claims. I claim:

1. Method of obtaining a sample of matter having a surface with a sampler comprising a receptacle and a piston that define a cavity, comprising:
advancing the sampler into the matter; and
maintaining the piston relative to the surface thereby enlarging the cavity;
wherein a portion of the matter is received in the cavity.

2. Method of claim 1, further comprising:
retracting the sampler from the matter; and
maintaining the piston relative to the sampler. thereby maintaining a volume of the cavity.

3. Method of claim 1, wherein the sampler further comprises a tip defining a passage, further comprising, prior to said advancing, orienting the tip so that matter may be received in the cavity.

4. Method of claim 1, wherein the sampler further comprises a tip defining a passage, further comprising, prior to said retracting , orienting the tip so that matter is discouraged from leaving the cavity.

5. Method of obtaining a sub-sample from a sample in a first chamber at a first pressure comprising:
placing a sub-sampler in a second chamber;
pressurizing the second chamber to a second pressure; and
enabling fluid communication between the first chamber and the second chamber;
whereby equalization of the first pressure and the second pressure defines a third pressure that differs from the first pressure by a predetermined amount.

6. Method of claim 5, wherein the predetermined amount is substantially zero.

7. Method of claim 5, the sub-sampler comprising a sleeve and a piston closely received in the sleeve, said method further comprising urging the sleeve into the sample, whereby the piston retreats into the sleeve responsive to an amount of the sample received in the sleeve.

8. Method of claim 7, wherein said urging comprises moving the sub-sampler from a third chamber defined by a housing received in the second chamber.

9. Method of claim 8, further comprising enabling fluid communication between the second chamber and the third chamber.

10. Method of claim 8, the sub-sampler further comprising a rod adapted to perform said urging, further comprising resisting lateral displacement of the rod during said urging.

11. Method of claim 7, further comprising one or both of:
puncturing a membrane over the sample; and
entering a port for accessing the sample.

12. Method of claim 7, further comprising:
withdrawing the sub-sampler from the first chamber; and one or both of:
disabling fluid communication between the first chamber and the second chamber; and
maintaining the sub-sampler in a third chamber at the third pressure.

13. Method of claim 12, wherein said withdrawing is one or both of:
enabled by magnetic coupling with a positioner for moving the sub-sampler relative to the second chamber; and
limited by interference of the sub-sampler relative to the second chamber or the third chamber.

14. Apparatus for obtaining a sub-sample from a sample in a first chamber at a first pressure comprising:
a sub-sampler;
a cylinder that defines a second chamber configured to receive said sub-sampler and be pressurized at a second pressure;
a valve configured to enable fluid communication and movement of said sub-sampler between the first chamber and said second chamber;
wherein equalization of the first pressure and the second pressure defines a third pressure that differs from the first pressure by a predetermined amount.

15. Apparatus of claim 14, wherein the predetermined amount is substantially zero.

16. Apparatus of claim 14, wherein said sub-sampler comprises:
a sleeve; and
a piston closely received in and configured to retreat into said sleeve responsive to an amount of the sample received in said sleeve.

17. Apparatus of claim 14, further comprising a housing that defines a third chamber configured to receive said sub-sampler and be pressurized at the third pressure.

18. Apparatus of claim 14, wherein said sub-sampler has a recess or an annular ring that defines a shoulder, further comprising:
a positioner configured to move said sub-sampler relative to said cylinder and having a distal end configured to one or both of:
selectably magnetically couple with said sub-sampler; and
be received in said recess;
whereby movement of said sub-sampler relative to said cylinder is limited by said shoulder.

19. Apparatus of claim 18, wherein said positioner is discouraged from lateral displacement when said positioner moves said sub-sampler relative to said cylinder.
